(19) United States
(12) Patent Application Publication
(10) Pub. No.: US 2019/0051922 A1
(43) Pub. Date: Feb. 14, 2019

(54) MEMBRANE ASSEMBLIES, ELECTRODE ASSEMBLIES, MEMBRANE-ELECTRODE ASSEMBLIES AND ELECTROCHEMICAL CELLS AND LIQUID FLOW BATTERIES THEREFROM

(71) Applicant: 3M INNOVATIVE PROPERTIES COMPANY, St. Paul, MN (US)

(72) Inventors: Kazuki Noda, Tokya (JP); Shunsuke Suzuki, Tokyo (JP)

(21) Appl. No.: 16/085,776

(22) PCT Filed: Mar. 15, 2017
(86) PCT No.: PCT/US2017/022480

§ 371 Date: Sep. 17, 2018

Related U.S. Application Data
(60) Provisional application No. 62/309,801, filed on Mar. 17, 2016.

(51) Int. Cl. H01M 8/18; H01M 8/1004; H01M 8/1053; H01M 8/1041; H01M 8/1062; H01M 8/1067; H01M 4/96

(52) U.S. Cl. CPC H01M 8/188; H01M 8/1004; H01M 8/1053; H01M 4/96; H01M 8/1062; H01M 8/1067; H01M 8/1055

(57) ABSTRACT

The present disclosure relates to membrane assemblies, electrode assemblies and membrane-electrode assemblies; and electrochemical cells and liquid flow batteries produced therefrom. The disclosure further provides methods of making the membrane assemblies, electrode assemblies and membrane-electrode assemblies. The membrane assemblies includes an ion permeable membrane and at least one transport protection layer. The electrode assemblies includes a porous electrode and a transport protection layer. The membrane-electrode assembly includes an ion permeable membrane, at least one transport protection layer and at least one porous electrode. The transport protection layer includes at least one of a woven and nonwoven non-conductive substrate comprising fiber and the water permeability @ 5 kPa of the transport protection layer is greater than or equal to about 100 ml/(cm² min).

### FIELD

The present invention generally relates to assemblies useful in the fabrication of electrochemical cells and batteries. In particular, the present invention relates to membrane assemblies, electrode assemblies and membrane-electrode assemblies; and electrochemical cells and liquid flow batteries produced therefrom. The disclosure further provides methods of making the membrane assemblies, electrode assemblies and membrane-electrode assemblies.

### BACKGROUND

Various components useful in the formation of electrochemical cells and redox flow batteries have been disclosed in the art. Such components are described in, for example, U.S. Pat. Nos. 5,648,184, 8,518,572 and 8,882,057.

### SUMMARY

In one embodiment, the present disclosure provides a membrane assembly for a liquid flow battery comprising:
an ion permeable membrane having a first surface and an opposed second surface;
a first transport protection layer having a first surface, an opposed second surface, fluid communication between the first surface and second surface and at least one of a volume porosity and an open area porosity is between about 0.80 and about 0.98, wherein the first surface of the ion permeable membrane is in contact with the first surface of the first transport protection layer and the first transport protection layer comprises at least one of a woven and nonwoven non-conductive substrate comprising fiber; and the water permeability @ 5 kPa of the first transport protection layer is greater than or equal to about 100 ml/(cm² min). Optionally, at least one of (i) the thickness of the transport protection layer may be between about 55 microns and 100 microns and (ii) an ionic resin may coat at least a portion of the fiber surface of the at least one of a woven and nonwoven substrate.

In another embodiment, the present disclosure provides a membrane assembly for a liquid flow battery comprising:
an ion permeable membrane having a first surface and an opposed second surface; and
a first transport protection layer having a first surface, an opposed second surface, fluid communication between the first surface and second surface and at least one of a volume porosity and open area porosity is between about 0.80 and about 0.98; wherein the first surface of the ion permeable membrane is in contact with the first surface of the first transport protection layer; and the first transport protection layer comprises at least one of a woven and nonwoven non-conductive substrate comprising; and the water permeability @ 5 kPa of the first transport protection layer is greater than or equal to about 100 ml/(cm² min); and
a second transport protection layer have a first surface, an opposed second surface, fluid communication between the first surface and second surface and at least one of a volume porosity and an open area porosity is between about 0.80 and about 0.98, wherein the second surface of the ion permeable membrane is in contact with the first surface of the second transport protection layer and the second transport protection layer comprises at least one of a woven and nonwoven non-conductive substrate comprising fiber; the water permeability @ 5 kPa of the second transport protection layer is greater than or equal to about 100 ml/(cm² min). Optionally, at least one of (i) the thickness of the first and/or second transport protection layer may be between about 50 microns and 130 microns and (ii) an ionic resin may coat at least a portion of the fiber surface of the at least one of a woven and nonwoven substrate of at least one of the first and second transport protection layers.

In another embodiment, the present disclosure provides an electrode assembly for a liquid flow battery comprising:
a porous electrode having a first surface and an opposed second surface comprising:
   carbon fiber;
   a first transport protection layer having a first surface, an opposed second surface, fluid communication between the first surface and second surface and at least one of a volume porosity and an open area porosity of greater than about 0.80 and less than about 0.98, wherein the first surface of the porous electrode is proximate the second surface of the first transport protection layer and the first transport protection layer comprises at least one of a woven and nonwoven non-conductive substrate comprising fiber; and the water permeability @ 5 kPa of the first transport protection layer is greater than or equal to about 100 ml/(cm² min). Optionally, at least one of (i) the thickness of the transport protection layer may be between about 50 microns and 130 microns and (ii) an ionic resin may coat at least a portion of the fiber surface of the at least one of a woven and nonwoven substrate.

In another embodiment, the present disclosure provides a membrane-electrode assembly for a liquid flow battery comprising:
an ion permeable membrane having a first surface and an opposed second surface;
a first and second transport protection layer each having a first surface, an opposed second surface, fluid communication between the first surface and second surface and at least one of a volume porosity and an open area porosity of greater than about 0.80 and less than about 0.98, wherein the first surface of the ion permeable membrane is in contact with the first surface of the first transport protection layer and the second surface of the ion permeable membrane is in contact with the first surface of the second transport protection layer, and the first and second transport protection layers comprise at least one of a woven and nonwoven non-conductive substrate comprising fiber; and the water permeability @ 5 kPa of at least one of the first and second transport protection layer is greater than or equal to about 100 ml/(cm² min); and
a first and second porous electrode each comprising carbon fiber and each having a first surface and an opposed second surface, wherein the first surface of the first porous electrode is proximate to the second surface of the first transport protection layer and the first surface of the second porous electrode is proximate to the second surface of the second transport protection layer. Optionally, at least one of (i) the thickness of the first and/or second transport protection layer may be between about 50 microns and 130 microns and (ii) an ionic resin, may coat at least a portion of the fiber surface of the at least one of a woven and nonwoven substrate of at least one of the first and second transport protection layers.

In another embodiment the present disclosure provides an electrochemical cell for a liquid flow battery comprising a membrane assembly according to any one of the membrane assemblies of the present disclosure.

In another embodiment the present disclosure provides an electrochemical cell for a liquid flow battery comprising an electrode assembly according to any one of the electrode assemblies of the present disclosure.

In another embodiment the present disclosure provides an electrochemical cell for a liquid flow battery comprising a membrane-electrode assembly according to any one of the membrane-electrode assemblies of the present disclosure.

In another embodiment the present disclosure provides a liquid flow battery comprising a membrane assembly according to any one of the membrane assemblies of the present disclosure.

In another embodiment the present disclosure provides a liquid flow battery comprising an electrode assembly according to any one of the electrode assemblies of the present disclosure.

In another embodiment the present disclosure provides a liquid flow battery comprising a membrane-electrode assembly according to any one of the membrane-electrode assemblies of the present disclosure.

### BRIEF DESCRIPTION OF THE DRAWINGS

FIG. 1A is a schematic cross-sectional side view of an exemplary membrane assembly according to one exemplary embodiment of the present disclosure.

FIG. 1B is a schematic cross-sectional side view of an exemplary membrane assembly according to one exemplary embodiment of the present disclosure.

FIG. 2 is a schematic cross-sectional side view of an exemplary electrode assembly according to one exemplary embodiment of the present disclosure.

FIG. 3 is a schematic cross-sectional side view of an exemplary membrane-electrode assembly according to one exemplary embodiment of the present disclosure.

FIG. 4 is a schematic cross-sectional side view of an exemplary electrochemical cell according to one exemplary embodiment of the present disclosure.

FIG. 5 is a schematic cross-sectional side view of an exemplary electrochemical cell stack according to one exemplary embodiment of the present disclosure.

FIG. 6 is a schematic view of an exemplary single cell liquid flow battery according to one exemplary embodiment of the present disclosure.

FIG. 7A is a schematic cross-sectional top view of an in-plane water permeability test apparatus (through the plane of the U-shaped gasket and transportation protection layer) of the present disclosure.

FIG. 7B is a schematic cross-sectional side view (through the indicated line in FIG. 7A) of the in-plane water permeability test apparatus of FIG. 7A.

Repeated use of reference characters in the specification and drawings is intended to represent the same or analogous features or elements of the disclosure. The drawings may not be drawn to scale. As used herein, the word “between”, as applied to numerical ranges, includes the endpoints of the ranges, unless otherwise specified. The recitation of numerical ranges by endpoints includes all numbers within that range (e.g. 1 to 5 includes 1, 1.5, 2, 2.75, 3, 3.80, 4, and 5) and any range within that range. Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

It should be understood that numerous other modifications and embodiments can be devised by those skilled in the art, which fall within the scope and spirit of the principles of the disclosure. All scientific and technical terms used herein have meanings commonly used in the art unless otherwise specified. The definitions provided herein are to facilitate understanding of certain terms used frequently herein and are not meant to limit the scope of the present disclosure. As used in this specification and the appended claims, the singular forms “a”, “an”, and “the” encompass embodiments having plural referents, unless the context clearly dictates otherwise. As used in this specification and the appended claims, the term “or” is generally employed in its sense including “and/or” unless the context clearly dictates otherwise.

Throughout this disclosure, when a surface of one substrate is in “contact” with the surface of another substrate, there are no intervening layer(s) between the two substrates and at least a portion of the surfaces of the two substrates are in physical contact.

Throughout this disclosure, if a surface of one substrate is “proximate” a surface of another substrate, the two surface are considered to be facing one another and to be in close proximity to one another, i.e. to be within less than 500 microns, less than 250 microns, less than 100 microns or even in contact with one another. However, there may be one or more intervening layers between the substrate surfaces.

Throughout this disclosure, if a layer or a surface of a layer is “adjacent” to a second layer or a surface of a second layer, the two nearest surfaces of the two layers are considered to be facing one another. They may be in contact with one another or they may not be in contact with one another, an intervening third layer(s) or substrate(s) being disposed between them.

Throughout this disclosure the phrase “non-conductive” refers to a material or substrate that is non-electrically conductive, unless otherwise stated. In some embodiments, a material or substrate is non-electrically conductive if it has an electrical resistivity of greater than about 1000 ohm-m.

Throughout this disclosure, unless indicated otherwise, the word “fiber” is meant to include both the singular and plural forms.

Throughout this disclosure fluid communication between a first surface and a second surface of a substrate means that a fluid, e.g. gas and/or liquid, is capable of flowing from a first surface of the substrate, through the thickness of a substrate, to a second surface of the substrate. This inherently implies that there is a continuous void region extending from the first surface of the substrate, through the thickness of the substrate, to a second surface of the substrate.

### DETAILED DESCRIPTION

A single electrochemical cell, which may be used in the fabrication of a liquid flow battery (e.g. a redox flow battery), generally, includes two porous electrodes, an anode and a cathode; an ion permeable membrane disposed between the two electrodes, providing electrical insulation between the electrodes and providing a path for one or more select ionic species to pass between the anode and cathode half-cells; anode and cathode flow plates, the former positioned adjacent the anode and the later positioned adjacent the cathode, each containing one or more channels which allow the anolyte and catholyte electrolytic solutions to contact and penetrate into the anode and cathode, respectively. The membrane along with at least one of the anode and cathode anode will be referred to herein as a membrane-electrode assembly (MEA). In a redox flow battery containing a single electrochemical cell, for example, the cell would also include two current collectors, one adjacent to and in contact with the exterior surface of the anode flow plate and one adjacent to and in contact with the exterior surface of the cathode flow plate. The current collectors allow electrons generated during cell discharge to connect to an external circuit and do useful work. A functioning redox flow battery or electrochemical cell also includes an anolyte, anolyte reservoir and corresponding fluid distribution system (piping and at least one or more pumps) to facilitate flow of anolyte into the anode half-cell, and a catholyte, catholyte reservoir and corresponding fluid distribution system to facilitate flow of catholyte into the cathode half-cell. Although pumps are typically employed, gravity feed systems may also be used. During discharge, active species, e.g. cations, in the anolyte are oxidized and the corresponding electrons flow though the exterior circuit and load to the cathode where they reduce active species in the catholyte. As the active species for electrochemical oxidation and reduction are contained in the anolyte and catholyte, redox flow cells and batteries have the unique feature of being able to store their energy outside the main body of the electrochemical cell, i.e. in the anolyte. The amount of storage capacity is mainly limited by the amount of anolyte and catholyte and the concentration of active species in these solutions. As such, redox flow batteries may be used for large scale energy storage needs associated with wind farms and solar energy plants, for example, by scaling the size of the reservoir tanks and active species concentrations, accordingly. Redox flow cells also have the advantage of having their storage capacity being independent of their power. The power in a redox flow battery or cell is generally determined by the size and number of electrode-membrane assemblies along with their corresponding flow plates (sometimes referred to in total as a “stack”) within the battery. Additionally, as redox flow batteries are being designed for electrical grid use, the voltages must be high. However, the voltage of a single redox flow electrochemical cell is generally less than 3 volts (difference in the potential of the half-cell reactions making up the cell). As such, hundreds of cells are required to be connected in series to generate voltages great enough to have practical utility and a significant amount of the cost of the cell or battery relates to the cost of the components making an individual cell.

At the core of the redox flow electrochemical cell and battery is the membrane-electrode assembly (e.g. anode, cathode and ion permeable membrane disposed there between). The design of the MEA is critical to the power output of a redox flow cell and battery. Subsequently, the materials selected for these components are critical to performance. Materials used for the electrodes may be based on carbon, which provides desirable catalytic activity for the oxidation/reduction reactions to occur and is electrically conductive to provide electron transfer to the flow plates. The electrode materials may be porous, to provide greater surface area for the oxidation/reduction reactions to occur. Porous electrodes may include carbon fiber based papers, felts, and cloths. When porous electrodes are used, the electrolytes may penetrate into the body of the electrode, access the additional surface area for reaction and thus increase the rate of energy generation per unit volume of the electrode. Also, as one or both of the anolyte and catholyte may be water based, i.e. an aqueous solution, there may be a need for the electrode to have a hydrophilic surface, to facilitate electrolyte permeation into the body of a porous electrode. Surface treatments may be used to enhance the hydrophilicity of the redox flow electrodes. This is in contrast to fuel cell electrodes which typically are designed to be hydrophobic, to prevent moisture from entering the electrode and corresponding catalyst layer/region, and to facilitate removal of moisture from the electrode region in, for example, a hydrogen/oxygen based fuel cell.

Materials used for the ion permeable membrane are required to be good electrical insulators while enabling one or more select ions to pass through the membrane. These material are often fabricated from polymers and may include ionic species to facilitate ion transfer through the membrane. Thus, the material making up the ion permeable membrane may be an expensive specialty polymer. As hundreds of MEAs may be required per cell stack and battery, the ion permeable membrane may be a significant cost factor with respect to the overall cost of the MEA and the overall cost of a cell and battery. As it is desirable to minimize the cost of the MEAs, one approach to minimizing their cost is to reduce the volume of the ion permeable membrane used therein. However, as the power output requirements of the cell help define the size requirements of a given MEA and thus the size of the membrane, with respect to its length and width dimensions (larger length and width, generally, being preferred), it may only be possible to decrease the thickness of the ion permeable membrane, in order to decrease the cost of the MEA. However, by decreasing the thickness of the ion permeable membrane, a problem has been identified. As the membrane thickness has been decreased, it has been found that the relatively stiff fibers, e.g. carbon fibers, used to fabricate the porous electrodes, can penetrate through the thinner membrane and contact the corresponding electrode of the opposite half-cell. This causes detrimental localized shorting of the cell, a loss in the power generated by the cell and a loss in power of the overall battery. Thus, there is a need for improved membrane-electrode assemblies that can prevent this localized shorting while maintaining the required ion transport through the membrane without inhibiting the required oxidation/reduction reaction of the electrochemical cells and batteries fabricated therefrom.

The present disclosure provides MEAs having a new design that includes at least one transport protection layer disposed between the membrane and electrode. The transport protection layer protects the ion permeable membrane from puncture by the fibers of the electrode and thus prevents localized shorting that has been found to be an issue in other MEA designs. The transport protection layers of the present disclosure may also improve fluid flow within the membrane-electrode assembly and subsequently fluid flow within an electrochemical cell and/or battery. This may lead to improved, i.e. decreased, or at least not significantly altered cell resistance, contrary to what one might expect to occur with the inclusion of an additional layer within the membrane-electrode assembly and subsequently with the inclusion of an additional layer in an electrochemical cell and/or battery. The MEAs with at least one transport protection layer are useful in the fabrication of liquid flow, e.g. redox flow, electrochemical cells and batteries. Liquid flow electrochemical cells and batteries may include cells and batteries having a single half-cell being a liquid flow type or both half-cells being a liquid flow type. The transport protection layer may be a component of a membrane assembly (MA) and/or an electrode assembly (EA) that is used to fabricate the MEAs. The present disclosure also includes liquid flow electrochemical cells and batteries containing MEAs that include at least one transport protection layer. The present disclosure further provides methods of fabricating membrane assemblies, electrode assemblies and membrane-electrode assemblies useful in the fabrication of liquid flow electrochemical cells and batteries.

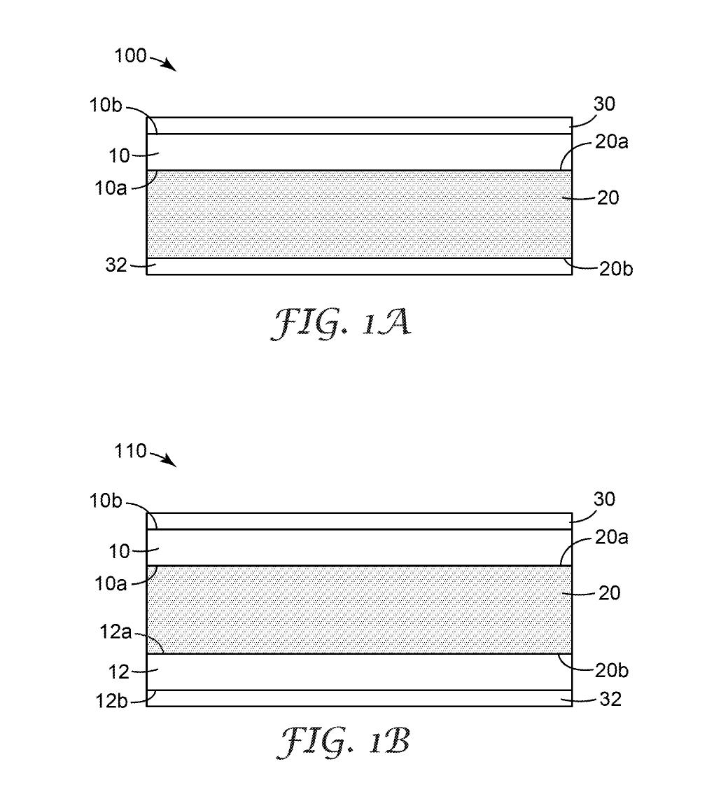

FIGS. 1A, 1B, 2 and 3 disclose a membrane assembly that includes at least one transport protection layer, a membrane assembly that includes at least two transport protection layers, an electrode assembly that includes at least one transport protection layer and a membrane-electrode assembly that includes at least one transport protection layer, respectively. In one embodiment of the present disclosure, a membrane assembly includes a first transport protection layer. FIG. 1A shows a schematic cross-sectional side view of membrane assembly 100, including an ion permeable membrane 20 having a first surface 20a and an opposed second surface 20b, a first transport protection layer 10 having a first surface 10a and an opposed second surface 10b. First surface 20a of ion permeable membrane 20 is in contact with first surface 10a of first transport protection layer 10. Membrane assembly 100 may further include one or more optional release liner 30, 32. Conventional release liners known in the art may be used for optional release liners 30 and 32.

In another embodiment of the present disclosure a membrane assembly includes a first and second transport protection layer. FIG. 1B shows a schematic cross-sectional side view of membrane assembly 110, including an ion permeable membrane 20 having a first surface 20a and an opposed second surface 20b, a first transport protection layer 10 having a first surface 10a and an opposed second surface 10b and a second transport protection layer 12 having a first surface 12a and an opposed second surface 12b. First surface 20a of ion permeable membrane 20 is in contact with first surface 10a of first transport protection layer 10. Second surface 20b of ion permeable membrane 20 is in contact with first surface 12a of second transport protection layer 12. Membrane assembly 110 may further include one or more optional release liners 30, 32. The optional release liners 30 and 32 may remain with the membrane assembly until it is used to fabricate a membrane-electrode assembly, in order to protect the outer surface of the transport protection layer from dust and debris. The release liners may also provide mechanical support and prevent tearing of the transport protection layer and/or marring of its surface, prior to fabrication of the membrane-electrode assembly. Conventional release liners known in the art may be used for optional release liners 30 and 32.

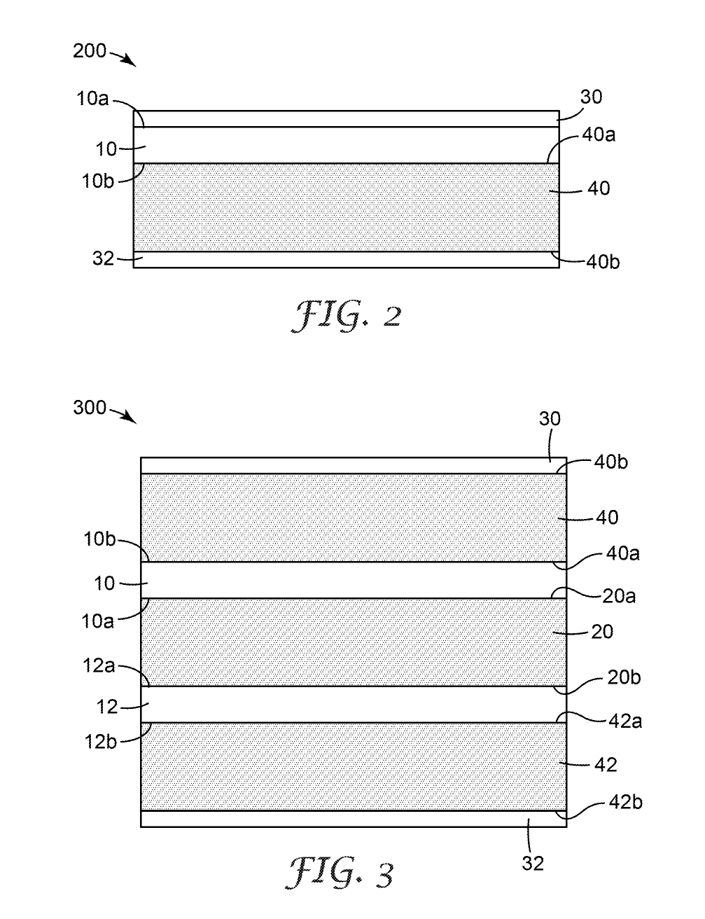

Another embodiment of the present disclosure includes an electrode assembly having a porous electrode and a first transport protection layer. FIG. 2 shows a schematic cross-sectional side view of an electrode assembly 200 including a porous electrode 40 comprising carbon fiber (not shown) having a first surface 40a and an opposed second surface 40b, and a first transport protection layer 10 having a first surface 10a and an opposed second surface 10b. In some embodiments, the first surface 40a of porous electrode 40 is adjacent the second surface 10b of the first transport protection layer 10. In some embodiments, the first surface 40a of porous electrode 40 is proximate the second surface 10b of the first transport protection layer 10. In some embodiments, the first surface 40a of porous electrode 40 is in contact with the second surface 10b of the first transport protection layer 10. Electrode assembly 200 may further include one or more optional release liners 30, 32. The optional release liners 30 and 32 may remain with the electrode assembly until it is used to fabricate a membrane-electrode assembly, in order to protect the outer surfaces of the transport protection layer and porous electrode from dust and debris. The release liners may also provide mechanical support and prevent tearing of the transport protection layer and porous electrode and/or marring of their surfaces, prior to fabrication of the membrane-electrode assembly. Conventional release liners known in the art may be used for optional release liners 30 and 32.

The transport protection layers of the present disclosure include at least one of a woven and nonwoven non-conductive substrate comprising fiber and, in some embodiments, may also include an ionic resin, which coats at least a portion of the fiber surface of the at least one of a woven and nonwoven substrate. In some embodiments, the ionic resin coats at least 10%, at least 20%, at least 30%, at least 40%, at least 50%, at least 60%, at least 70%, at least 75%, at least 80%, at least 85%, at least 90%, at least 95% or even at least 100% of the fiber surface of the at least one of a woven and nonwoven substrate. The ionic resin of the transport protection layer should allow the select ion(s) of the electrolytes to transfer through the transport protection layer. This may be achieved by allowing the electrolyte to easily wet and absorb into a given transport protection layer. The material properties, particularly the surface wetting characteristics of the transport protection layer (the surface wetting characteristics of the at least one of a woven and nonwoven non-conductive substrate and/or ionic resin, e.g. ionic resin coating which coats at least a portion of the fiber surface of the at least one of a woven and nonwoven non-conductive substrate) may be selected based on the type of anolyte and catholyte solution, i.e. whether they are aqueous based or non-aqueous based. As disclosed herein, an aqueous based solution is defined as a solution wherein the solvent includes at least 50% water by weight. A non-aqueous base solution is defined as a solution wherein the solvent contains less than 50% water by weight. In some embodiments, the transport protection layer may be hydrophilic. This may be particularly beneficial when the transport protection layers are to be used in conjunction with aqueous anolyte and/or catholyte solutions. In some embodiments the transport protection layer may have a surface contact angle with water, catholyte and/or anolyte of less than 90 degrees. In some embodiments, the transport protection layer may have a surface contact angle with water, catholyte and/or anolyte of between about 85 degrees and about 0 degrees, between about 70 degrees and about 0 degrees, between about 50 degrees and about 0 degrees, between about 30 degrees and about 0 degrees, between about 20 degrees and about 0 degrees, or even between about 10 degrees and about 0 degrees. In some embodiments, the ionic resin of the transport protection layer may have a surface contact angle with water, catholyte and/or anolyte of less than 90 degrees. In some embodiments, the ionic resin of the transport protection layer may have a surface contact with water, catholyte and/or anolyte of between about 85 degrees and about 0 degrees, between about 70 degrees and about 0 degrees, between about 50 degrees and about 0 degrees, between about 30 degrees and about 0 degrees, between about 20 degrees and about 0 degrees, or even between about 10 degrees and about 0 degrees. In some embodiments, the ionic resin of the transport protection layer may have a surface contact angle with water, catholyte and/or anolyte of less than 90 degrees. In some embodiments, the woven and nonwoven non-conductive substrate of the transport protection layer may have a surface contact with water, catholyte and/or anolyte of between about 85 degrees and about 0 degrees, between about 70 degrees and about 0 degrees, between about 50 degrees and about 0 degrees, between about 30 degrees and about 0 degrees, between about 20 degrees and about 0 degrees, or even between about 10 degrees and about 0 degrees. In some embodiments, the first transport protection layer and the second transport protection layer are the same composition. In some embodiments, the first transport protection layer and the second transport protection layer are different compositions.

The optional ionic resin of the transport protection layer may include, but is not limited to, ion exchange resins, ionomer resins and combinations thereof. Ion exchange resins may be particularly useful. The optional ionic resin of the transport protection layer may include polymer resin wherein a fraction of the repeat units are electrically neutral and a fraction of the repeat units have an ionic functional group, i.e. an ionic repeat unit. In some embodiments, the resin is an ionic resin, wherein the ionic resin has a mole fraction of repeat units having an ionic functional group of between about 0.005 and about 1. The optional ionic resin of the transport protection layer may include thermoplastic resins (including thermoplastic elastomer), thermoset resins (including glassy and rubbery materials) and combinations thereof. The optional ionic resin may be formed from a precursor ionic resin containing one or more of monomer and oligomer which may be cured to form an ionic resin, e.g. an ionic resin coating at least a portion of the fiber surface of the at least one of a woven and nonwoven non-conductive substrate. The precursor ionic resin may also contain dissolved polymer. The precursor ionic resin may contain solvent which is removed prior to or after curing of the precursor ionic resin. The optional ionic resin may be formed from a dispersion of ionic resin particles, the solvent of the dispersion being removed to form the ionic resin which coats at least a portion of the fiber surface of the at least one of a woven and nonwoven non-conductive substrate of the transport protection layer. The optional ionic resin may be dispersed or dissolved in a solvent, the solvent being removed to form the ionic resin which coats at least a portion of the fiber surface of the at least one of a woven and nonwoven non-conductive substrate of transport protection layer. Ionic resins may include conventional thermoplastics and thermosets that have been modified by conventional techniques, to include at least one of type of ionic functional group, e.g. anionic and/or cationic. Useful thermoplastic resins that may be modified include, but are not limited to, at least one of polyethylene, e.g. high molecular weight polyethylene, high density polyethylene, ultra-high molecular weight polyethylene, polypropylene, e.g. high molecular weight polypropylene, polystyrene, poly(meth)acrylates, e.g. polyacrylates based on acrylic acid that may have the acid functional group exchanged for, for example, an alkali metal, chlorinated polyvinyl chloride, polytetrafluoroethylene (PTFE), e.g. high molecular weight PTFE, fluoropolymer, e.g. perfluorinated fluoropolymer and partially fluorinated fluoropolymer each of which may be semi-crystalline and/or amorphous, polyetherimides and polyketones. Useful thermoset resins include, but are not limited to, at least one of epoxy resin, phenolic resin, polyurethanes, urea-formadehyde resin and melamine resin. Ionic resin include, but are not limited to, ion exchange resins, ionomer resins and combinations thereof. Ion exchange resins may be particularly useful.

As broadly defined herein, ionic resin include resin wherein a fraction of the repeat units are electrically neutral and a fraction of the repeat units have an ionic functional group. In some embodiments, the ionic resin has a mole fraction of repeat units with ionic functional groups between about 0.005 and 1. In some embodiments, the ionic resin is a cationic resin, i.e. its ionic functional groups are negatively charged and facilitate the transfer of cations, e.g. protons, optionally, wherein the cationic resin is a proton cationic resin. In some embodiments, the ionic resin is an anionic exchange resin, i.e. its ionic functional groups are positively charged and facilitate the transfer of anions. The ionic functional group of the ionic resin may include, but is not limited, to carboxylate, sulphonate, sulfonamide, quaternary ammonium, thiuronium, guanidinium, imidazolium and pyridinium groups. Combinations of ionic functional groups may be used in an ionic resin.

Ionomer resin include resin wherein a fraction of the repeat units are electrically neutral and a fraction of the repeat units have an ionic functional group. As defined herein, an ionomer resin will be considered to be a resin having a mole fraction of repeat units having ionic functional groups of no greater than about 0.15. In some embodiments, the ionomer resin has a mole fraction of repeat units having ionic functional groups of between about 0.005 and about 0.15, between about 0.01 and about 0.15 or even between about 0.3 and about 0.15. In some embodiments the ionomer resin is insoluble in at least one of the anolyte and catholyte. The ionic functional group of the ionomer resin may include, but is not limited, to carboxylate, sulphonate, sulfonamide, quaternary ammonium, thiuronium, guanidinium, imidazolium and pyridinium groups. Combinations of ionic functional groups may be used in an ionomer resin. Mixtures of ionomer resins may be used. The ionomers resin may be a cationic resin or an anionic resin. Useful ionomer resin include, but are not limited to NAFION, available from DuPont, Wilmington, Del.; AQUIVION, a perfluorosulfonic acid, available from SOLVAY, Brussels, Belgium; FLEMION and SELEMION, fluoropolymer ion exchange resin, from Asahi Glass, Tokyo, Japan; FUMASEP ion exchange resin, including FKS, FKB, FKL, FKE cation exchange resins and FAB, FAA, FAP and FAD anionic exchange resins, available from Fumatek, Bietigheim-Bissingen, Germany, polybenzimidazols, perfluorosulfonic acid ionomer having an 825 equivalent weight, available under the trade designation “3M825EW”, available as a powder or aqueous solution, from the 3M Company, St. Paul, Minn., perfluorosulfonic acid ionomer having an 725 equivalent weight, available under the trade designation “3M725EW”, available as a powder or aqueous solution, from the 3M Company, and ion exchange materials and membranes described in U.S. Pat. No. 7,348,088, incorporated herein by reference in its entirety.

Ion exchange resin include resin wherein a fraction of the repeat units are electrically neutral and a fraction of the repeat units have an ionic functional group. As defined herein, an ion exchange resin will be considered to be a resin having a mole fraction of repeat units having ionic functional groups of greater than about 0.15 and less than about 1.00. In some embodiments, the ion exchange resin has a mole fraction of repeat units having ionic functional groups of greater than about 0.15 and less than about 0.90, greater than about 0.15 and less than about 0.80, greater than about 0.15 and less than about 0.70, greater than about 0.30 and less than about 0.90, greater than about 0.30 and less than about 0.80, greater than about 0.30 and less than about 0.70 greater than about 0.45 and less than about 0.90, greater than about 0.45 and less than about 0.80, and even greater than about 0.45 and less than about 0.70. The ion exchange resin may be a cationic exchange resin or may be an anionic exchange resin. The ion exchange resin may, optionally, be a proton ion exchange resin. The type of ion exchange resin may be selected based on the type of ion that needs to be transported between the anolyte and catholyte through the ion permeable membrane, e.g. ion exchange membrane. In some embodiments the ion exchange resin is insoluble in at least one of the anolyte and catholyte. The ionic functional group of the ion exchange resin may include, but is not limited, to carboxylate, sulphonate, sulfonamide, quaternary ammonium, thiuronium, guanidinium, imidazolium and pyridinium groups. Combinations of ionic functional groups may be used in an ion exchange resin. Mixtures of ion exchange resins resin may be used. Useful ion exchange resins include, but are not limited to, fluorinated ion exchange resins, e.g. perfluorosulfonic acid copolymer and perfluorosulfonimide copolymer, a sulfonated polysulfone, a polymer or copolymer containing quaternary ammonium groups, a polymer or copolymer containing at least one of guanidinium or thiuronium groups a polymer or copolymer containing imidazolium groups, a polymer or copolymer containing pyridinium groups. The optional ionic resin may be a mixture of ionomer resin and ion exchange resin.

The transport protection layers of the present disclosure include at least one of a woven and nonwoven non-conductive substrate comprising fiber. In some embodiments, the at least one of a woven and nonwoven substrate may be at least one of a woven and nonwoven paper, felt, mat and cloth, i.e. fabric. In some embodiments, the transport protection layers includes a woven non-conductive substrate and is free of a nonwoven non-conductive substrate. In some embodiments, the transport protection layers includes a nonwoven non-conductive substrate and is free of a woven non-conductive substrate. The woven and nonwoven non-conductive substrate of the transport protection layer may be organic, inorganic or combinations thereof. The woven and nonwoven non-conductive substrate of the transport protection layer may include and at least one of an inorganic woven and inorganic nonwoven non-conductive substrate, e.g. an inorganic paper, felt, mat and/or cloth (fabric). The woven and nonwoven non-conductive substrate of the transport protection layer may include at least one of a polymeric woven and polymeric nonwoven non-conductive substrate, e.g. a polymeric paper, felt, mat and/or cloth (fabric). The at least one woven and nonwoven non-conductive substrate may include at least one of a non-conductive polymeric material and a non-conductive inorganic material. The woven and nonwoven non-conductive substrate may comprise fiber, e.g. a plurality of fibers. The woven and nonwoven non-conductive substrate may be fabricated from at least one of non-conductive polymeric fiber and non-conductive inorganic fiber. In some embodiments, the woven and nonwoven non-conductive substrate may include at least one of non-conductive polymeric fiber and non-conductive inorganic fiber. In some embodiments, the woven and nonwoven non-conductive substrate may include non-conductive polymeric fiber and exclude non-conductive inorganic fiber. In some embodiments, the woven and nonwoven non-conductive substrate may include non-conductive inorganic fiber and exclude non-conductive polymeric fiber. In some embodiments, the woven and nonwoven non-conductive substrate may include both non-conductive inorganic fiber and non-conductive polymeric fiber.

In some embodiments, the fibers of the at least one woven and nonwoven non-conductive substrate comprising fibers may have aspect ratios of the length to width and length to thickness both of which are greater about 10 and a width to thickness aspect ratio less than about 5. For a fiber having a cross sectional area that is in the shape of a circle, the width and thickness would be the same and would be equal to the diameter of the circular cross-section. There is no particular upper limit on the length to width and length to thickness aspect ratios of a fiber. Both the length to thickness and length to width aspect ratios of the fiber may be between about 10 and about 1000000, between 10 and about 100000, between 10 and about 1000, between 10 and about 500, between 10 and about 250, between 10 and about 100, between about 10 and about 50, between about 20 and about 1000000, between 20 and about 100000, between 20 and about 1000, between 20 and about 500, between 20 and about 250, between 20 and about 100 or even between about 20 and about 50. The width and thickness of the fiber may each be from between about 0.001 to about 100 microns, from between about 0.001 microns to about 50 microns, from between about 0.001 to about 25 microns, from between about 0.001 microns to about 10 microns, from about 0.001 microns to about 1 microns, from between about 0.01 to about 100 microns, from between about 0.01 microns to about 50 microns, from between about 0.01 to about 25 microns, from between about 0.01 microns to about 10 microns, from about 0.01 microns to about 1 microns, from between about 0.05 to about 100 microns, from between about 0.05 microns to about 50 microns, from between about 0.05 to about 25 microns, from between about 0.05 microns to about 10 microns, from about 0.05 microns to about 1 microns, from between about 0.1 to about 100 microns, from between about 0.1 microns to about 50 microns, from between about 0.1 to about 25 microns, from between about 0.1 microns to about 10 microns, or even from between about 0.1 microns to about 1 microns. In some embodiments the thickness and width of the fiber may be the same.

The fibers may be fabricated into at least one of a woven and nonwoven non-conductive substrate using conventional techniques. A nonwoven non-conductive substrate may be fabricated by a melt blown fiber process, spunbond process, a carding process and the like. In some embodiments, the length to thickness and length to width aspect ratios of the fiber may be greater than 1000000, greater than about 10000000 greater than about 100000000 or even greater than about 1000000000. In some embodiments, the length to thickness and length to width aspect ratios of the fiber may be between about 10 to about 1000000000; between about 10 and about 100000000 between about 10 and about 10000000, between about 20 to about 1000000000; between about 20 and about 100000000 between about 20 and about 10000000, between about 50 to about 1000000000; between about 50 and about 100000000 or even between about 50 and about 10000000.

The at least one of a woven and nonwoven non-conductive substrate may include conventional woven and nonwoven paper, felt, mats and cloth (fabrics) known in the art. The at least one of a woven and nonwoven non-conductive substrate may include at least one of non-conductive polymeric fiber and non-conductive inorganic fiber. The number of types, i.e. non-conductive polymeric fiber types and/or non-conductive inorganic fiber types, used to form the at least one of a woven and nonwoven non-conductive substrate, is not particularly limited. The non-conductive polymeric fiber may include at least one non-conductive polymer, e.g. one non-conductive polymer composition or one non-conductive polymer type. The non-conductive polymeric fiber may include at least two non-conductive polymers, i.e. two non-conductive polymer compositions or two non-conductive polymer types. For example, the non-conductive polymeric fiber may include one set of fibers composed of polyethylene and another set of fibers composed of polypropylene. If at least two non-conductive polymers are used, the first non-conductive polymeric fiber may have a lower glass transition temperature and or melting temperature than the second non-conductive polymeric fiber. The first non-conductive polymeric fiber may be used for fusing the non-conductive polymeric fiber of the at least one of a woven and nonwoven non-conductive substrate together, to improve, for example, the mechanical properties of the at least one of a woven and nonwoven non-conductive substrate. The non-conductive inorganic fiber may include at least one non-conductive inorganic, e.g. one non-conductive inorganic composition or one non-conductive inorganic type. The non-conductive inorganic fiber may include at least two non-conductive inorganics, i.e. two non-conductive inorganic compositions or two non-conductive inorganic types. The at least one of a woven and nonwoven non-conductive substrate may include at least one of non-conductive polymeric fiber, e.g. one non-conductive polymer composition or non-conductive polymer type, and at least one non-conductive inorganic fiber, e.g. one non-conductive inorganic composition or one non-conductive inorganic type. For example, the at least one of a woven and nonwoven non-conductive substrate may include polyethylene fiber and glass fiber.

In some embodiments, the at least one of a woven and nonwoven non-conductive substrate may include small amounts of one or more conductive material, so long as the conductive material does not alter the at least one of a woven and nonwoven non-conductive substrate to be conductive. In some embodiments, the at least one of a woven and nonwoven non-conductive substrate is substantially free of conductive material. In this case, “substantially free of conductive material” means that the at least one of a woven and nonwoven non-conductive substrate includes less than about 25% by wt., less than about 20% by wt., less than about 15% by wt., less than about 10% by wt., less than about 5% by wt., less than about 3% by wt., less than about 2%, by weight, less than about 1% by wt., less than about 0.5% by wt., less than about 0.25% by wt., less than about 0.1% by wt., or even 0.0% by wt. conductive material.

The non-conductive polymeric fiber of the at least one of a woven and nonwoven non-conductive substrate is not particularly limited, except that it is non-conductive. In some embodiments, the non-conductive polymeric fiber of the at least one of a woven and nonwoven non-conductive substrate may include least one of a thermoplastic and thermoset. Thermoplastics may include thermoplastic elastomers. A thermoset may include a B-stage polymer. In some embodiments, non-conductive polymeric fiber of the at least one of a woven and nonwoven non-conductive substrate includes, but is not limited to, at least one of epoxy resin, phenolic resin, polyurethanes, urea-formadehyde resin, melamine resin, polyesters, e.g. polyethylene terephthalate, polyamides, polyethers, polycarbonates, polyimides, polysulphones, polyphenylene oxides, polyacrylates, polymethacylates, polyolefin, e.g. polyethylene and polypropylene, styrene and styrene based random and block copolymers, e.g. styrene-butadiene-styrene, polyvinyl chloride, and fluorinated polymers, e.g. polyvinylidene fluoride and polytetrafluoroethylene. In some embodiments, the non-conductive polymeric fiber comprises at least one of polyurethanes, polyesters, polyamides, polyethers, polycarbonates, polyimides, polysulphones, polyphenylene oxides, polyacrylates, polymethacylates, polyolefin, styrene and styrene based random and block copolymers, polyvinyl chloride, and fluorinated polymers.

The non-conductive inorganic fiber of the at least one of a woven and nonwoven non-conductive substrate is not particularly limited, except that it is non-conductive. In some embodiments, the non-conductive inorganic fiber of the at least one of a woven and nonwoven non-conductive substrate may include a ceramic. The ceramic may include, but is not limited to metal oxides, for example silicon oxide, e.g. glass and doped glass, and aluminum oxide. In some embodiments, the non-conductive inorganic fiber of the at least one of a woven and nonwoven non-conductive substrate includes, but is not limited to, at least one of a ceramic, e.g. silicone oxide and aluminum oxide; boron; silicon; magnesium silicate, e.g. hydrated magnesium silicate; Wollastonite, e.g. calcium silicate, and rock wool.

The ratio of the weight of the optional ionic resin to total weight of the transport protection layer is not particularly limited. In some embodiments, the ratio of the weight of the ionic resin to the total weight of the transport protection layer is from about 0.03 to about 0.95, from about 0.03 to about 0.90, from about 0.03 to about 0.85, from about 0.03 to about 0.80, from about 0.03 to about 0.70, from about 0.05 to about 0.95, from about 0.05 to about 0.90, from about 0.05 to about 0.85, from about 0.05 to about 0.80, from about 0.05 to about 0.70, from about 0.10 to about 0.95, from about 0.10 to about 0.90, from about 0.10 to about 0.85, from about 0.10 to about 0.80, from about 0.10 to about 0.70, from about 0.20 to about 0.95, from about 0.20 to about 0.90, from about 0.20 to about 0.85, from about 0.20 to about 0.80, from about 0.20 to about 0.70, from about 0.30 to about 0.95, from about 0.30 to about 0.90, from about 0.30 to about 0.85, from about 0.30 to about 0.80, from about 0.30 to about 0.70, from about 0.40 to about 0.95, from about 0.40 to about 0.90, from about 0.40 to about 0.85, from about 0.40 to about 0.80, or even from about 0.40 to about 0.70.

Useful thicknesses of the transport protection layer may be from about 5 microns to about 500 microns, from about 5 microns to about 400 microns, from about 5 microns to about 300 microns, from about 5 microns to about 200 microns, from about 10 microns to about 500 microns, from about 10 microns to about 400 microns, from about 10 microns to about 300 microns, from about 10 microns to about 200 microns, from about 25 microns to about 500 microns, from about 25 microns to about 400 microns, from about 25 microns to about 300 microns, from about 25 microns to about 200 microns, from about 50 microns to about 500 microns, from about 50 microns to about 400 microns, from about 50 microns to about 300 microns, from about 50 microns to about 200 microns, from about 65 microns to about 500 microns, from about 65 microns to about 400 microns, from about 65 microns to about 300 microns, from about 65 microns to about 200 microns, from about 75 microns to about 500 microns, from about 75 microns to about 400 microns, from about 75 microns to about 300 microns, or even from about 75 microns to about 200 microns.

In some embodiments, to maximize the resistance to shorting of a cell or battery (associated with carbon fiber penetration of the ion permeable membrane), it may be desirable to have a thicker transport protection layer. In these embodiments, the thickness of the transport protection layer may be on the higher end of the ranges of thickness described above. For example, the thickness of the transport protection layer may be from about 25 microns to about 500 microns, from about 25 microns to about 400 microns, from about 25 microns to about 300 microns, from about 25 microns to about 200 microns, from about 50 microns to about 500 microns, from about 50 microns to about 400 microns, from about 50 microns to about 300 microns, from about 50 microns to about 200 microns, from about 65 microns to about 500 microns, from about 65 microns to about 400 microns, from about 65 microns to about 300 microns, from about 65 microns to about 200 microns, from about 75 microns to about 500 microns, from about 75 microns to about 400 microns, from about 75 microns to about 300 microns, or even from about 75 microns to about 200 microns.

In some embodiments, to enhance cell resistance and/or short resistance, the thickness of the transport protection layer may be between about 50 microns and about 130 microns, between about 50 microns and about 110 microns, between about 50 microns and about 100 microns, between about 50 microns and about 90 microns, between about 50 microns and about 80 microns, between about 55 microns and about 130 microns, between about 55 microns and about 110 microns, between about 55 microns and about 100 microns, between about 55 microns and about 90 microns, between about 55 microns and about 80 microns, between about 60 microns and about 80 microns or even between about 60 microns and about 75 microns.

In some embodiments, in order to improve the cell resistance (lower the cell resistance), it may be desirable to have a thinner transport protection layer. In these embodiments, the thickness of the transport protection layer may be on the lower end of the ranges of thickness described above. For example, the thickness of the transport protection layer may 5 microns to about 200 microns, from about 5 microns to about 150 microns, from about 5 microns to about 100 microns, from about 10 microns to about 200 microns, from about 10 microns to about 150 microns, or even from about 10 microns to about 100 microns.

In some embodiments, at least one of the volume porosity and open area porosity of the transport protection layer may be between about 0.10 and about 0.98, between about 0.10 and about 0.95, about 0.10 and about 0.90, about 0.10 and about 0.85, about 0.10 and about 0.75, between about 0.15 and about 0.98, between about 0.15 and about 0.95, between about 0.15 and about 0.90, between about 0.15 and about 0.85, between about 0.15 and about 0.75, between about 0.25 and about 0.98, between about 0.25 and about 0.95, between about 0.25 and about 0.90, between about 0.25 and about 0.85, between about 0.25 and about 0.75, between about 0.35 and about 0.98, between about 0.35 and about 0.95, between about 0.35 and about 0.90, between about 0.35 and about 0.85, between about 0.35 and about 0.75, between about 0.45 and about 0.98, between about 0.45 and about 0.95, between about 0.45 and about 0.90, between about 0.45 and about 0.85, between about 0.45 and about 0.75, between about 0.50 and about 0.98, between about 0.50 and about 0.95, between about 0.50 and about 0.90, between about 0.50 and about 0.85, between about 0.50 and about 0.75, between about 0.65 and about 0.98, between about 0.65 and about 0.95, between about 0.65 and about 0.90, between about 0.80 and about 0.98, between about 0.80 and about 0.95 or even between about 0.80 and about 0.90.

The volume porosity of the transport protection layer is defined as the volume of the void space of the transport protection layer divided by the total volume, i.e. bulk volume, of the transport protection layer. Volume porosity may be determined by conventional techniques known in the art, e.g. direct methods, optical methods and gas expansion methods. For example, the volume porosity may be calculated from the following equation:

Volume Porosity=1−(Ds/Dm)
where,
Ds=density of a substrate (bulk density) in g/cm³ for example.
Dm=Density of the material making up the substrate in g/cm³ for example.

If the substrate happens to be a woven or nonwoven substrate containing more than one fiber type, then Dm is the weighted average density:

Weighted Average Density=D1(w1/w3)+D2(w2/w3)
where,
D1 is the density of component 1
D2 is the density of component 2
w1 is the weight of component 1
w2 is the weight of component 2
w3 is the total weight (w3=w1+w2)
   For example, for a nonwoven substrate having a density, Ds, of 0.3 g/cm³ made from polyethylene fiber having a density of 0.95 g/cm³, the volume porosity would be 1−(0.3/0.95) which is 0.684. The volume porosity is the volume fraction of pores or open volume in the substrate.

The open area porosity is the ratio of the area of the voids, e.g. through holes, to the total area of the surface of the transport protection layer at a major surface of the transport protection layer. The open area porosity may be determined by conventional techniques known in the art. The open area porosity may be calculated, for example, for a mesh having a rectangular hole of length, L, and width, W, and a fiber width or diameter for the weft fibers, Dwe, and warp fibers, Dwa, as follows (assuming the length of the hole corresponds to the direction of the warp fiber and the width of the hole corresponds to the direction of the weft fiber):

Open Area Porosity=(L×W)/[(L+Dwe)(W+Dwa)]

In some embodiments, to maximize the resistance to shorting of a cell or battery (associated with carbon fiber penetration of the ion permeable membrane), it may be desirable to have a less porous transport protection layer. In these embodiments, at least one of the volume porosity and open area porosity of the transport protection layer may be on the lower end of the ranges of volume porosity and/or open area porosity described above. For example, at least one of the volume porosity and open area porosity of the transport protection layer may be between about 0.10 and about 0.65, between about 0.10 and about 0.55, between about 0.10 and about 0.45, between about 0.10 and about 0.35, between about 0.15 and about 0.65, between about 0.15 and about 0.55, between about 0.15 and about 0.45, or even between about 0.15 and about 0.35.

In some embodiments, to increase the fluid flow, i.e. the flow of anolyte and/or catholyte, in a cell or battery in order to maximize the cell resistance (lower the cell resistance), it may be desirable to have a more porous transport protection layer. In these embodiments, at least one of the volume porosity and open area porosity of the transport protection layer may be on the higher end of the ranges of volume porosity and/or open area porosity described above. For example, at least one of the volume porosity and open area porosity of the transport protection layer may be between about 0.35 and about 0.98, between about 0.35 and about 0.95, between about 0.35 and about 0.90, between about 0.35 and about 0.85, between about 0.35 and about 0.75, between about 0.35 and about 0.98, between about 0.45 and about 0.95, between about 0.45 and about 0.90, between about 0.45 and about 0.85, or even between about 0.45 and about 0.75.

With respect to improving the short resistance and cell resistance of an electrochemical cell or battery containing a transport protection layer of the present disclosure, a change in the porosity, either increasing or decreasing, generally, will improve one of the parameters while adversely affecting the other parameter. However, it has been surprisingly found that the resistance to shorting (associated with carbon fiber penetration of the ion permeable membrane) of an electrochemical cell may be improved while at least not significantly changing and, in some cases, improving the cell resistance of an electrochemical cell containing a transport protection layer of the present disclosure. In these embodiments, at least one of the volume porosity and open area porosity of the transport protection layer may be between about 0.45 and about 0.98, between about 0.45 and about 0.95, between about 0.45 and about 0.90, between about 0.45 and about 0.85, between about 0.45 and about 0.75, between about 0.55 and about 0.98, between about 0.55 and about 0.95, between about 0.55 and about 0.90, between about 0.55 and about 0.85, between about 0.55 and about 0.80, between about 0.55 and about 0.75, or even between about 0.60 and about 0.75.

In some embodiments, the transport protection layer may be hydrophilic. This may be particularly beneficial when the transport protection layers are to be used in conjunction with aqueous anolyte and/or catholyte solutions. In some embodiments the transport protection layer may have a surface contact angle with water, catholyte and/or anolyte of less than 90 degrees. In some embodiments, the transport protection layer may have a surface contact angle with water, catholyte and/or anolyte of between about 85 degrees and about 0 degrees, between about 70 degrees and about 0 degrees, between about 50 degrees and about 0 degrees, between about 30 degrees and about 0 degrees, between about 20 degrees and about 0 degrees, or even between about 10 degrees and about 0 degrees. Uptake of a liquid, e.g. water, catholyte and/or anolyte, into the pores of a transport protection layer may be considered a key property for optimal operation of a liquid flow battery. In some embodiments, 100 percent of the pores of the transport protection layer may be filled by the liquid. In other embodiments, between about 30 percent and about 100 percent, between about 50 percent and about 100 percent, between about 70 percent and about 100 percent or even between about 80 percent and 100 percent of the pores of the transport protection layer may be filled by the liquid.

In some embodiments, the water permeability @ 5 kPa of the transport protection layer is greater than or equal to 80 ml/(cm² min), greater than or equal to 100 ml/(cm² min), greater than or equal to about 150 ml/(cm² min) or even greater than or equal to about 200 ml/(cm² min). In some embodiments, the water permeability @ 5 kPa of the transport protection layer is between about 100 ml/(cm² min) and about 1000 ml/(cm² min), between about 100 ml/(cm² min) and about 600 ml/(cm² min), between about 100 ml/(cm² min) and about 500 ml/(cm² min), between about 100 ml/(cm² min) and about 400 ml/(cm² min), between about 150 ml/(cm² min) and about 1000 ml/(cm² min), between about 150 ml/(cm² min) and about 600 ml/(cm² min), between about 150 ml/(cm² min) and about 500 ml/(cm² min), between about 150 ml/(cm² min) and about 400 ml/(cm² min), between about 200 ml/(cm² min) and about 1000 ml/(cm² min), between about 200 ml/(cm² min) and about 600 ml/(cm² min), between about 200 ml/(cm² min) and about 500 ml/(cm² min) or even between about 200 ml/(cm² min) and about 400 ml/(cm² min). The water permeability @ 5 kPa is measured using the “In-plane Water Permeability Test Method” described in the “EXAMPLES” section of the present disclosure. The larger the value of the water permeability @ 5 kPa, the greater the amount of fluid, e.g. water, anolyte and catholyte, that can flow through the transport protection layer at a given pressure. Higher fluid flow rates may improve electrochemical cell and liquid flow battery performance.

If an optional ionic resin is used, the transport protection layers of the present disclosure can be fabricated by coating the ionic resin on at least a portion of the fiber surface of the at least one of a woven and nonwoven non-conductive substrate. Coating techniques know in the art may be used including, but not limited to, brush coating, dip coating, spray coating, knife coating, e.g. slot-fed knife coating, notch bar coating, metering rod coating, e.g. Meyer bar coating, die coating, e.g. fluid bearing die coating, roll coating, e.g. three roll coating, curtain coating and the like.

In some embodiments, the ionic resin is coated on at least a portion of the fiber surface of the at least one of a woven and nonwoven non-conductive substrate in the form an ionic resin coating solution, e.g. a solution that includes the ionic resin, solvent and any other desired additives. The ionic resin coating solution may be coated on at least a portion of the fiber surface of the at least one of a woven and nonwoven non-conductive substrate. The volatile components of the ionic resin coating solution, e.g. solvent, are removed by drying, leaving the ionic resin on at least a portion of the fiber surface of the at least one of a woven and nonwoven non-conductive substrate. Ionic resin coating solutions may be prepared by solution blending, which includes combining the ionic resin, an appropriate solvent and any other desired additives, followed by mixing at the desired shear rate. Mixing may include using any techniques known in the art, including blade mixers and conventional milling, e.g. ball milling. Other additives to the ionic resin coating solutions may include, but are not limited to, surfactants, dispersants, thickeners, wetting agents and the like. Surfactants, dispersants and thickeners may help to facilitate the ability of the ionic resin coating solution to wet the fiber surface of the at least one of a woven and nonwoven non-conductive substrate. They may also serve as viscosity modifiers. Prior to making the coating solution, the optional ionic resin may be in the form of a dispersion or a suspension, as would be generated if the ionic resin was prepared via an emulsion polymerization technique or suspension polymerization technique, for example. Additives, such as surfactants, may be used to stabilize the ionic resin dispersion or suspension in their solvent.

Solvent useful in the ionic resin coating solution may be selected based on the ionic resin type. Solvents useful in the ionic resin coating solution include, but are not limited to, water, alcohols (e.g. methanol, ethanol and propanol), acetone, ethyl acetate, alkyl solvents (e.g. pentane, hexane, cyclohexane, heptane and octane), methyl ethyl ketone, ethyl ethyl ketone, dimethyl ether, petroleum ether, toluene, benzene, xylenes, dimethylformamide, dimethylsulfoxide, chloroform, carbon tetrachloride, chlorobenzene and mixtures thereof.

The amount of solvent, on a weight basis, in the ionic resin coating solution may be from about 5 to about 95 percent, from about 10 to about 95 percent, from about 20 to about 95 percent, from about 30 to about 95 percent, from about 40 to about 95 percent, from about 50 to about 95 percent, from about 60 to about 95 percent, from about 5 to about 90 percent, from about 10 to about 90 percent, from about 20 percent to about 90 percent, from about 30 to about 90 percent, from about 40 to about 90 percent, from about 50 to about 90 percent, from about 60 to about 90 percent, from about 5 to about 80 percent, from about 10 to about 80 percent from about 20 percent to about 80 percent, from about 30 to about 80 percent, from about 40 to about 80 percent, from about 50 to about 80 percent, from about 60 to about 80 percent, from about 5 percent to about 70 percent, from about 10 percent to about 70 percent, from about 20 percent to about 70 percent, from about 30 to about 70 percent, from about 40 to about 70 percent, or even from about 50 to about 70 percent.

Surfactants may be used in the ionic resin coating solutions, for example, to improve wetting. Surfactants may include cationic, anionic and nonionic surfactants. Surfactants useful in the ionic resin coating solution include, but are not limited to TRITON X-100, available from Dow Chemical Company, Midland, Mich.; DISPERSBYK 190, available from BYK Chemie GMBH, Wesel, Germany; amines, e.g. olyelamine and dodecylamine; amines with more than 8 carbons in the backbone, e.g. 3-(N, N-dimethyldodecylammonio) propanesulfonate (SB12); SMA 1000, available from Cray Valley USA, LLC, Exton, Pa.; 1,2-propanediol, triethanolamine, dimethylaminoethanol; quaternary amine and surfactants disclosed in U.S. Pat. Publ. No. 2013/0011764, which is incorporated herein by reference in its entirety. If one or more surfactants are used in the ionic resin coating solution, the surfactant may be removed from the transport protection layer by a thermal process, wherein the surfactant either volatilizes at the temperature of the thermal treatment or decomposes and the resulting compounds volatilize at the temperature of the thermal treatment. In some embodiments, the optional ionic resin is substantially free of surfactant. By “substantially free” it is meant that the ionic resin contains, by weight, from 0 percent to 0.5 percent, from 0 percent to 0.1 percent, from 0 percent to 0.05 percent or even from 0 percent to 0.01 percent surfactant. In some embodiments, the optional ionic resin contains no surfactant. Surfactant may be removed from the optional ionic resin by washing or rinsing with a solvent of the surfactant. Solvents include, but are not limited to water, alcohols (e.g. methanol, ethanol and propanol), acetone, ethyl acetate, alkyl solvents (e.g. pentane, hexane, cyclohexane, heptane and octane), methyl ethyl ketone, ethyl ethyl ketone, dimethyl ether, petroleum ether, toluene, benzene, xylenes, dimethylformamide, dimethylsulfoxide, chloroform, carbon tetrachloride, chlorobenzene and mixtures thereof.

The transport protection layer may be formed from the ionic resin coating solution by coating the solution on a liner or release liner. A first major surface of a woven or nonwoven non-conductive substrate may then be placed in contact with the ionic resin coating solution. The woven or nonwoven non-conductive substrate is removed from the liner and at least a portion of the fiber surface of the woven or nonwoven non-conductive substrate is coated with the ionic resin coating solution. Optionally, a new liner or the same liner may be coated with the same or a different ionic resin coating solution and the second major surface of a woven or nonwoven non-conductive substrate may then be placed in contact with the ionic resin coating solution. The woven or nonwoven non-conductive substrate is removed from the liner and at least a portion of the fiber surface of the woven or nonwoven non-conductive substrate is coated with the ionic resin coating solution. The woven or nonwoven non-conductive substrate is then exposed to a thermal treatment, e.g. heat from an oven or air flow through oven, in order to remove the volatile compounds, e.g. solvent, from the ionic resin coating solution, producing a transport protection layer having at least one of a woven and nonwoven non-conductive substrate comprising fiber; and an ionic resin, which coats at least a portion of the fiber surface of the at least one woven or nonwoven non-conductive substrate. An alternative approach to fabricating the transport protection layer would include coating the ionic resin coating solution directly onto the first and/or second major surfaces of the at least one of a woven and nonwoven non-conductive substrate, followed by a thermal treatment, e.g. heat from an oven or air flow through oven, in order to remove the volatile compounds, e.g. solvent, from the ionic resin coating solution, producing a transport protection layer having at least one of a woven and nonwoven non-conductive substrate comprising fiber; and an ionic resin, which coats at least a portion of the fiber surface of the at least one woven or nonwoven non-conductive substrate. If the amount of coating solution is too great after coating, the woven or nonwoven non-conductive substrate may be run through the nip of a two roll coater, for example, to remove some of the ionic resin coating solution, prior to thermal treatment.

If the optional ionic resin is in the from a precursor ionic resin, a transport protection layer may be formed by coating at least one major surface of a woven or nonwoven nonconductive substrate comprising fiber with the precursor resin, wherein at least a portion of the fiber surface of the woven or nonwoven nonconductive substrate is coated by the precursor ionic resin. The precursor ionic resin coating of the woven or nonwoven nonconductive substrate may then be cured by any technique known in the art including, but not limited to, thermal curing, actinic radiation curing and e-beam curing. The precursor ionic resin may contain one or more of curing agents, catalyst, chain transfer agents, chain extenders and the like, as dictated by the cure chemistry of the precursor ionic resin and the desired final properties of the ionic resin. Curing the ionic resin precursor produces a transport protection layer having at least one of a woven and nonwoven non-conductive substrate comprising fiber; and an ionic resin, which coats at least a portion of the fiber surface of the at least one woven or nonwoven non-conductive substrate.

In some embodiments, the transport protection layer may be laminated to a surface of the ion permeable membrane using conventional lamination techniques, which may include at least one of pressure and heat, thereby forming a membrane assembly a shown in FIG. 1A (without optional release liner 32). A second transport protection layer may be laminated to the opposite surface of the ion permeable membrane, thereby forming a membrane assembly, as shown in FIG. 1B. Lamination may include direct bonding, e.g. melt bonding the transport protection layer and the ion permeable membrane. If melt bonding is employed, at least the surface of at least one of the transport protection layer and ion permeable membrane are melted or heated to allow flow and then laminated together followed by cooling to fuse the transport protection layer and ion permeable membrane together.

The transport protection layer may have multiple layers. The number of layers forming the transport protection layer is not particularly limited. In some embodiments, the transport protection layer comprises at least one layer. In some embodiments, the transport protection layer comprises two or more layers. The layers of the transport protection layer may be the same composition or may include two or more different compositions.

The membrane assemblies and membrane-electrode assemblies of the present disclosure include an ion permeable membrane (element 20, of FIGS. 1A, 1B and 3). Ion permeable membranes known in the art may be used. Ion permeable membranes are often referred to as separators and may be prepared from ion exchange resins, for example, those previously discussed for the optional ionic resin of the transport protection layer. In some embodiments, the ion permeable membranes may include a fluorinated ion exchange resin. Ion permeable membranes useful in the embodiments of the present disclosure may be fabricated from ion exchange resins and/or ionomer known in in the art or be commercially available as membrane films and include, but are not limited to, NAFION PFSA MEMBRANES, available from DuPont, Wilmington, Del.; AQUIVION PFSA, a perfluorosulfonic acid, available from SOLVAY, Brussels, Belgium; FLEMION and SELEMION, fluoropolomer ion exchange membranes, available from Asahi Glass, Tokyo, Japan; FUMASEP ion exchange membranes, including FKS, FKB, FKL, FKE cation exchange membranes and FAB, FAA, FAP and FAD anionic exchange membranes, available from Fumatek, Bietigheim-Bissingen, Germany and ion exchange membranes, perfluorosulfonic acid ionomer having an 825 equivalent weight, available under the trade designation “3M825EW”, available as a powder or aqueous solution, from the 3M Company, St. Paul, Minn., perfluorosulfonic acid ionomer having an 725 equivalent weight, available under the trade designation “3M725EW”, available as a powder or aqueous solution, from the 3M Company and materials described in U.S. Pat. No. 7,348,088, incorporated herein by reference in its entirety. The ion exchange resins useful in the fabrication of the ion permeable membrane may be the ion exchange resin and/or ionomer resins previously disclosed herein with respect to the transport protection layer. In some embodiments, the ion permeable membrane includes a fluoropolymer. In some embodiments, the fluoropolymer of the ion permeable membrane may contain between about 10% to about 90%, from about 20% to about 90%, from about 30% to about 90% or even from about 40% to about 90% fluorine by weight.

The ion permeable membranes of the present disclosure may be obtained as free standing films from commercial suppliers or may be fabricated by coating a solution of the appropriate ion permeable membrane resin in an appropriate solvent, and then heating to remove the solvent. The ion permeable membrane may be formed from an ion permeable membrane coating solution by coating the solution on a release liner and then drying the ion permeable membrane coating solution coating to remove the solvent.

Any suitable method of coating may be used to coat the ion permeable membrane coating solution on a release liner. Typical methods include both hand and machine methods, including hand brushing, notch bar coating, fluid bearing die coating, wire-wound rod coating, fluid bearing coating, slot-fed knife coating, and three-roll coating. Most typically three-roll coating is used. Coating may be achieved in one pass or in multiple passes. Coating in multiple passes may be useful to increase coating weight without corresponding increases in cracking of the ion permeable membrane.

The amount of solvent, on a weight basis, in the ion permeable membrane coating solution may be from about 5 to about 95 percent, from about 10 to about 95 percent, from about 20 to about 95 percent, from about 30 to about 95 percent, from about 40 to about 95 percent, from about 50 to about 95 percent, from about 60 to about 95 percent, from about 5 to about 90 percent, from about 10 to about 90 percent, from about 20 percent to about 90 percent, from about 30 to about 90 percent, from about 40 to about 90 percent, from about 50 to about 90 percent, from about 60 to about 90 percent, from about 5 to about 80 percent, from about 10 to about 80 percent from about 20 percent to about 80 percent, from about 30 to about 80 percent, from about 40 to about 80 percent, from about 50 to about 80 percent, from about 60 to about 80 percent, from about 5 percent to about 70 percent, from about 10 percent to about 70 percent, from about 20 percent to about 70 percent, from about 30 to about 70 percent, from about 40 to about 70 percent, or even from about 50 to about 70 percent.

The amount of ion permeable resin (e.g. ionic resins, including ion exchange resins and ionomer resins), on a weight basis, in the ion permeable membrane coating solution may be from about 5 to about 95 percent, from about 5 to about 90 percent, from about 5 to about 80 percent, from about 5 to about 70 percent, from about 5 to about 60 percent, from about 5 to about 50 percent, from about 5 to about 40 percent, from about 10 to about 95 percent, from about 10 to about 90 percent, from about 10 to about 80 percent, from about 10 to about 70 percent, from about 10 to about 60 percent, from about 10 to about 50 percent, from about 10 to about 40 percent, from about 20 to about 95 percent, from about 20 to about 90 percent, from about 20 to about 80 percent, from about 20 to about 70 percent, from about 20 to about 60 percent, from about 20 to about 50 percent, from about 20 to about 40 percent, from about 30 to about 95 percent, from about 30 to about 90 percent, from about 30 to about 80 percent, from about 30 to about 70 percent, from about 30 to about 60 percent, or even from about 30 to about 50 percent.

The thickness of the ion permeable membrane may be from about 5 microns to about 250 microns, from about 5 microns to about 200 microns, from about 5 microns to about 150 microns, from about 5 microns to about 100 microns, from about 10 microns to about 250 microns, from about 10 microns to about 200 microns, from about 10 microns to about 150 microns, from about 5 microns to about 100 microns, from about 15 microns to about 250 microns, from about 15 microns to about 200 microns, from about 15 microns to about 150 microns, or even from about 15 microns to about 100 microns.

The electrode assemblies and membrane-electrode assemblies of the present disclosure include at least one porous electrode including carbon fiber. The porous electrode of the present disclosure is electrically conductive and the porosity facilitates the oxidation/reduction reaction that occur therein by increasing the amount of active surface area for reaction to occur, per unit volume of electrode, and by allowing the anolyte and catholyte to permeate into the porous regions and access this additional surface area. The porous electrodes including carbon fiber may include at least one of woven and nonwoven fiber mats, woven and nonwoven fiber papers, felts and cloths (fabrics). The carbon fiber of the porous electrode may include, but is not limited to, glass like carbon, amorphous carbon, graphene, carbon nanotubes and graphite. Particularly useful porous electrode materials include carbon papers, carbon felts and carbon cloths (fabrics). In one embodiment, the porous electrode includes at least one of carbon paper, carbon felt and carbon cloth.

The thickness of the porous electrode may be from about 10 microns to about 1000 microns, from about 10 microns to about 500 microns, from about 10 microns to about 250 microns, from about 10 microns to about 100 microns, from about 25 microns to about 1000 microns, from about 25 microns to about 500 microns, from about 25 microns to about 250 microns, or even from about 25 microns to about 100 microns. The porosity of the porous electrodes, on a volume basis, may be from about 5 percent to about 95 percent, from about 5 percent to about 90 percent, from about 5 percent to about 80 percent, from about 5 percent to about 70 percent, from about 10 percent to about 95 percent, from about 10 percent to 90 percent, from about 10 percent to about 80 percent, from about 10 percent to about 70 percent, from about 10 percent to about 70 percent, from about 20 percent to about 95 percent, from about 20 percent to about 90 percent, from about 20 percent to about 80 percent, from about 20 percent to about 70 percent, from about 20 percent to about 70 percent, from about 30 percent to about 95 percent, from about 30 percent to about 90 percent, from about 30 percent to about 80 percent, or even from about 30 percent to about 70 percent.

The amount of carbon fiber in the porous electrode may be at least about 30%, at least about 40%, at least about 50%, at least about 60%, at least about 70%, at least about 80%, at least about 90% or even at least about 95% by weight.

The porous electrode may be a single layer or multiple layers of woven and nonwoven fiber mats and woven and nonwoven fiber papers, felts, and cloths, multi-layer papers and felts having particular utility. When the porous electrode includes multiple layers, there is no particular limit as to the number of layers that may be used. However, as there is a general desire to keep the thickness of the electrode assemblies and the membrane assemblies of the present disclosure as thin as possible, the porous electrode may include from about 2 to about 20 layers, from about 2 to about 10 layers, from about 2 to about 8 layer, from about 2 to about 5 layers, from about 3 to about 20 layers, from about 3 to about 10 layers, from about 3 to about 8 layers, or even from about 3 to about 5 layers of woven and nonwoven fiber mats and woven and nonwoven fiber papers, felts, and cloths. In some embodiments the porous electrode includes from about 2 to about 20 layers, from about 2 to about 10 layers, from about 2 to about 8 layer, from about 2 to about 5 layers, from about 3 to about 20 layers, from about 3 to about 10 layers, from about 3 to about 8 layers, or even from about 3 to about 5 layers of carbon paper, carbon felt and/or carbon cloth.

In some embodiments, the porous electrode may be surface treated to enhance the wettability of the porous electrode to a given anolyte or catholyte or to provide or enhance the electrochemical activity of the porous electrode relative to the oxidation-reduction reactions associated with the chemical composition of a given anolyte or catholyte. Surface treatments include, but are not limited to, at least one of chemical treatments, thermal treatments and plasma treatments. Thermal treatments of porous electrodes may include heating to elevated temperatures in an oxidizing atmosphere, e.g. oxygen and air. Thermal treatments may be at temperatures from about 100 to about 1000 degrees centigrade, from about 100 to about 850 degrees centigrade, from about 100 to about 700 degrees centigrade, 200 to about 1000 degrees centigrade, from about 200 to about 850 degrees centigrade, from about 200 to about 700 degrees centigrade, from about 300 to about 1000 degrees centigrade, from about 300 to about 850 degrees centigrade, or even from about 300 to about 700 degrees centigrade. The duration of the thermal treatment may be from about 0.1 hours to about 60 hours, from about 0.25 hour to about 60 hours, from about 0.5 hour to about 60 hours, from about 1 hour to about 60 hours, from about 3 hours to about 60 hours, from about 0.1 hours to about 48 hours, from about 0.25 hour to about 48 hours, from about 0.5 hour to about 48 hours, from about 1 hour to about 48 hours, from about 3 hours to about 48 hours, from about 0.1 hours to about 24 hours, from about 0.25 hour to about 24 hours, from about 0.5 hour to about 24 hours, from about 1 hour to about 24 hours from about 3 hours to about 24 hours, from about 0.1 hours to about 12 hours, from about 0.25 hour to about 12 hours, from about 0.5 hour to about 12 hours, from about 1 hour to about 12 hours, or even from about 3 hours to about 48 hours. In some embodiments, the porous electrode includes at least one of a carbon paper, carbon felt and carbon cloth that has been thermally treated in at least one of an air, oxygen, hydrogen, nitrogen, argon and ammonia atmosphere at a temperature from about 300 degrees centigrade to about 700 degrees centigrade for between about 0.0.1 hours and 12 hours.

In some embodiments, the porous electrode may be hydrophilic. This may be particularly beneficial when the porous electrode is to be used in conjunction with aqueous anolyte and/or catholyte solutions. Uptake of a liquid, e.g. water, catholyte and/or anolyte, into the pores of a liquid flow battery electrode may be considered a key property for optimal operation of a liquid flow battery. In some embodiments, 100 percent of the pores of the electrode may be filled by the liquid, creating the maximum interface between the liquid and the electrode surface. In other embodiments, between about 30 percent and about 100 percent, between about 50 percent and about 100 percent, between about 70 percent and about 100 percent or even between about 80 percent and 100 percent of the pores of the electrode may be filled by the liquid. In some embodiments, the porous electrode may have a surface contact angle with water, catholyte and/or anolyte of less than 90 degrees. In some embodiments, the porous electrode may have a surface contact angle with water, catholyte and/or anolyte of between about 85 degrees and about 0 degrees, between about 70 degrees and about 0 degrees, between about 50 degrees and about 0 degrees, between about 30 degrees and about 0 degrees, between about 20 degrees and about 0 degrees, or even between about 10 degrees and about 0 degrees.

Electrode assemblies may be fabricated similarly to the fabrication of the membrane assemblies, except the ion permeable membrane is replace by the porous electrode. An electrode assembly may be formed by laminating a porous electrode to the second surface of a previously formed transport protection layer (FIG. 2, without optional release liners 30 and 32). Lamination may include direct bonding, e.g. melt bonding the transport protection layer to the porous electrode. If melt bonding is employed, at least the surface of at least one of the transport protection layer and porous electrode are melted or heated to allow flow and then laminated together followed by cooling to fuse the transport protection layer and porous electrode together.

In some embodiments, the present disclosure also provides membrane-electrode assemblies. The transport protection layers, ion permeable membranes, porous electrodes and their corresponding membrane assemblies and electrode assemblies of the present disclosure may be used to fabricate membrane-electrode assemblies. FIG. 3 shows a schematic cross-sectional side view of a membrane-electrode assembly 300. Membrane-electrode assembly 300 includes an ion permeable membrane 20 having a first surface 20a and an opposed second surface 20b; a first and second transport protection layer, 10 and 12, respectively, each having a first surface, 10a and 12a, respectively, and an opposed second surface, 10b and 12b, respectively. The first surface 20a of ion permeable membrane 20 is in contact with first surface 10a of first transport protection layer 10 and second surface 20b of ion permeable membrane 20 is in contact with first surface 12a of the second transport protection layer. Membrane-electrode assembly 300 further includes a first and second porous electrode, 40 and 42 respectively, each having a first surface, 40a and 42a, respectively, and an opposed second surface, 40b and 42b, respectively; wherein the first surface 40a of first porous electrode 40 is adjacent, proximate or in contact with the second surface 10b of first transport protection layer 10 and first surface 42a of the second porous electrode 42 is adjacent, proximate or in contact with second surface 12b of second transport protection layer 12. In some embodiments, first surface 40a of first porous electrode 40 is adjacent second surface 10b of the first transport protection layer 10. In some embodiments, first surface 42a of second porous electrode 42 is in adjacent second surface 12b of second transport protection layer 12. In some embodiments, first surface 40a of first porous electrode 40 is proximate second surface 10b of the first transport protection layer 10. In some embodiments, first surface 42a of second porous electrode 42 is proximate second surface 12b of second transport protection layer 12. In another embodiment, first surface 40a of first porous electrode 40 is in contact with second surface 10b of first transport protection layer 10. In another embodiment first surface 42a of second porous electrode 42 is in contact with second surface 12b of second transport protection layer 12. Membrane-electrode assembly 300 may further include one or more optional release liners 30, 32.

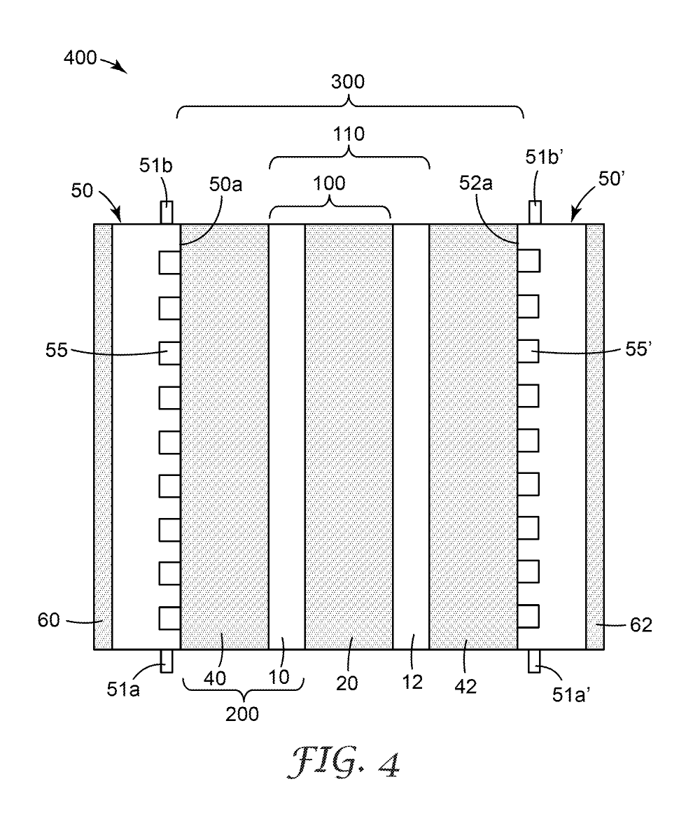

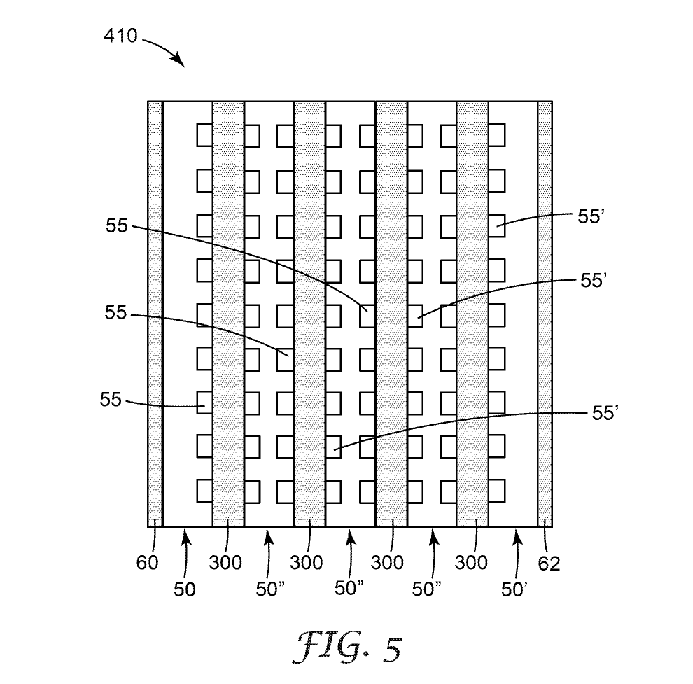

The transport protection layers, ion permeable membranes, porous electrodes and their corresponding membrane assemblies, electrode assemblies and membrane-electrode assemblies of the present disclosure may be used to fabricate an electrochemical cell for use in, for example, a liquid flow battery, e.g. a redox flow battery. In some embodiments, the present disclosure provides an electrochemical cell that include one or more of a membrane assembly, an electrode assembly and a membrane-electrode assembly. In one embodiment, the present disclosure provides an electrochemical cell including a membrane assembly according to any one of the membrane assemblies of the present disclosure. In another embodiment, the present disclosure provides an electrochemical cell including an electrode assembly according to any one of the electrode assemblies of the present disclosure. In yet another embodiment, the present disclosure provides an electrochemical cell including a membrane-electrode assembly according to any one of the membrane-electrode assemblies of the present disclosure. FIG. 4 shows a schematic cross-sectional side view of electrochemical cell 400, which includes membrane-electrode assembly 300, end plates 50 and 50′ having fluid inlet ports, 51a and 51a′, respectively, and fluid outlet ports, 51b and 51b′, respectively, flow channels 55 and 55′, respectively and first surface 50a and 52a respectively. Electrochemical cell 400 also includes current collectors 60 and 62. Membrane-electrode assembly 300 is as described in FIG. 3. Electrochemical cell 400 includes porous electrodes 40 and 42, transport protection layers 10 and 12 and ion permeable membrane 20, all as previously describe. End plates 50 and 51 are in electrical communication with porous electrodes 40 and 42, respectively, through surfaces 50a and 52a, respectively. Support plates, not shown, may be placed adjacent to the exterior surfaces of current collectors 60 and 62. The support plates are electrically isolated from the current collector and provide mechanical strength and support to facilitate compression of the cell assembly. In some embodiments, electrochemical cell 400 includes a membrane assembly 100, including an ion permeable membrane 20 having a first surface 20a and an opposed second surface 20b, a first transport protection layer 10 having a first surface 10a and an opposed second surface 10b. First surface 20a of ion permeable membrane 20 is in contact with first surface 10a of first transport protection layer 10 (see FIG. 1A). In some embodiments, electrochemical cell 400 includes a membrane assembly 110, including an ion permeable membrane 20 having a first surface 20a and an opposed second surface 20b, a first transport protection layer 10 having a first surface 10a and an opposed second surface 10b and a second transport protection layer 12 having a first surface 12a and an opposed second surface 12b. First surface 20a of ion permeable membrane 20 is in contact with first surface 10a of first transport protection layer 10. Second surface 20b of ion permeable membrane 20 is in contact with first surface 12a of second transport protection layer 12 (see FIG. 1B). In some embodiments, electrochemical cell 400 includes an electrode assembly 200 including a porous electrode 40 having a first surface 40a and an opposed second surface 40b, and a first transport protection layer 10 having a first surface 10a and an opposed second surface 10b. In some embodiments, the first surface 40a of porous electrode 40 is adjacent, proximate or in contact with the second surface 10b of the first transport protection layer 10. In some embodiments, the first surface 40a of porous electrode 40 is in contact with the second surface 10b of the first transport protection layer 10 (see FIG. 2). End plates 50 and 50′ include fluid inlet and outlet ports and flow channels that allow anolyte and catholyte solutions to be circulated through the electrochemical cell. Assuming the anolyte is flowing through plate 50 and the catholyte is flowing through plate 50′, the flow channels 55 allow the anolyte to contact and flow into porous electrode 40, facilitating the oxidation-reduction reactions of the cell. Similarly, for the catholyte, the flow channels 55′ allow the catholyte to contact and flow into porous electrode 42, facilitating the oxidation-reduction reactions of the cell. The current collectors may be electrically connected to an external circuit.

The electrochemical cells of the present disclosure may include multiple electrode-membrane assemblies fabricated from at least one of the membrane assemblies, electrode assemblies, transport protection layers, porous electrodes and ion permeable membranes disclosed herein. In one embodiment of the present disclosure, an electrochemical cell is provided including at least two membrane-electrode assemblies, according to any one of the membrane-electrode assemblies described herein. FIG. 5 shows a schematic cross-sectional side view of electrochemical cell stack 410 including membrane-electrode assemblies 300, separated by bipolar plates 50″ and end plates 50 and 50′ having flow channels 55 and 55′. Bipolar plates 50″ allow anolyte to flow through one set of channels, 55 and catholyte to flow through a seconds set of channels, 55′, for example. Cell stack 410 includes multiple electrochemical cells, each cell represented by a membrane-electrode assembly and the corresponding adjacent bipolar plates and/or end plates. Support plates, not shown, may be placed adjacent to the exterior surfaces of current collectors 60 and 62. The support plates are electrically isolated from the current collector and provide mechanical strength and support to facilitate compression of the cell assembly. The anolyte and catholyte inlet and outlet ports and corresponding fluid distribution system is not show. These features may be provided as known in the art.

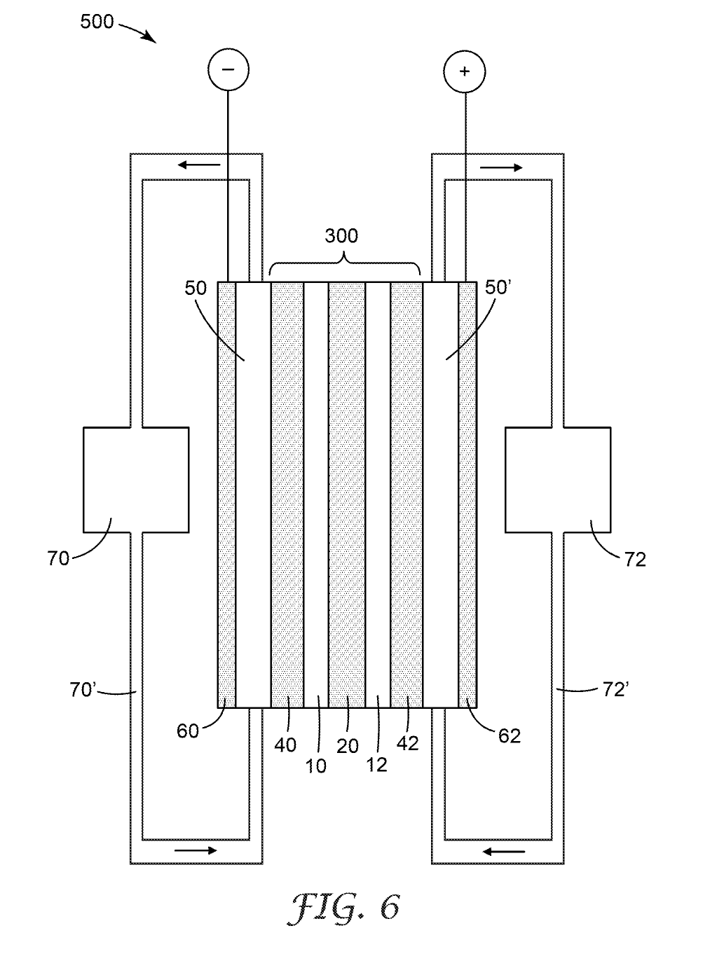

The transport protection layers, ion permeable membranes, porous electrodes and their corresponding membrane assemblies, electrode assemblies and membrane-electrode assemblies of the present disclosure may be used to fabricate a liquid flow battery, e.g. a redox flow battery. In some embodiments, the present disclosure provides a liquid flow battery that include one or more of a membrane assembly, an electrode assembly and a membrane-electrode assembly. In one embodiment, the present disclosure provides a liquid flow battery including a membrane assembly according to any one of the membrane assemblies of the present disclosure. In another embodiment, the present disclosure provides a liquid flow battery including an electrode assembly according to any one of the electrode assemblies of the present disclosure. In yet another embodiment, the present disclosure provides a liquid flow battery including a membrane-electrode assembly according to any one of the membrane-electrode assemblies of the present disclosure. FIG. 6 shows a schematic view of an exemplary single cell, liquid flow battery 500 including membrane-electrode assembly 300, which includes transport protection layers 10 and 12, ion permeable membrane 20 and porous electrodes 40 and 42, current collectors 60 and 62, anolyte reservoir 70 and anolyte fluid distribution 70′, and catholyte reservoir 72 and catholyte fluid distribution system 72′. Pumps for the fluid distribution system are not shown. Current collectors 60 and 62 may be connected to an external circuit which includes an electrical load (not shown). Although a single cell liquid flow battery is shown, it is known in the art that liquid flow batteries may contain multiple electrochemical cells, i.e. a cell stack. Further multiple cell stacks may be used to form a liquid flow battery, e. g. multiple cell stacks connected in series. The transport protection layers, ion permeable membranes, porous electrodes and their corresponding membrane assemblies, electrode assemblies and membrane-electrode assemblies of the present disclosure may be used to fabricate liquid flow batteries having multiple cells, for example, multiple cell stack of FIG. 5. Flow fields may be present, but this is not a requirement.

The membrane assemblies, electrode assemblies and membrane-electrode assemblies of the present disclosure may provide improved cell short resistance and cell resistance. Cell short resistance is a measure of the resistance an electrochemical cell has to shorting, for example, due to puncture of the membrane by conductive fibers of the electrode. In some embodiments, a test cell, as described in the Example section of the present disclosure, which includes at least one of a membrane assembly, electrode assembly and membrane-electrode assembly of the present disclosure may have a cell short resistance of greater than 1000 ohm-cm², greater than 5000 ohm-cm² or even greater than 10000 ohm-cm². In some embodiments the cell short resistance may be less than about 10000000 ohm-cm². Cell resistance is a measure of the electrical resistance of an electrochemical cell through the membrane assembly, i.e. laterally across the cell, shown in FIG. 4. In some embodiments, a test cell, as described in the Example section of the present disclosure, which includes at least one of a membrane assembly, electrode assembly and membrane-electrode assembly of the present disclosure may have a cell resistance of between about, 0.01 and about 10 ohm-cm², 0.01 and about 5 ohm-cm², between about 0.01 and about 1 ohm-cm², between about 0.04 and about 0.5 ohm-cm² or even between about 0.07 and about 0.1 ohm-cm².

In some embodiments of the present disclosure, the liquid flow battery may be a redox flow battery, for example, a vanadium redox flow battery (VRFB), wherein a V³⁺/V²⁺ sulfate solution serves as the negative electrolyte (“anolyte”) and a V⁵⁺/V⁴⁺ sulfate solution serves as the positive electrolyte (“catholyte”). It is to be understood, however, that other redox chemistries are contemplated and within the scope of the present disclosure, including, but not limited to, V²⁺/V³⁺ vs. Br⁻/ClBr₂, Br₂/Br⁻ vs. S/S²⁻, Br⁻/Br₂ vs. Zn²⁺/Zn, Ce⁴⁺/Ce³⁺ vs. V²⁺/V³⁺, Fe³⁻/Fe²⁺ vs. Br₂/Br⁻, Mn²⁺/Mn³⁺ vs. Br₂/Br⁻, Fe³⁺/Fe²⁺ vs. Ti²⁺/Ti⁴⁺ and Cr³⁺/Cr²⁺, acidic/basic chemistries. Other chemistries useful in liquid flow batteries include coordination chemistries, for example, those disclosed in U.S. Pat. Appl. Nos. 2014/028260, 2014/0099569, and 2014/0193687 and organic complexes, for example, U.S. Pat. Publ. No. 2014/370403 and international application published under the patent cooperation treaty Int. Publ. No. WO 2014/052682, all of which are incorporated herein by reference in their entirety.

Methods of making membrane-electrode assemblies include laminating the exposed surface of a transport protection layer of a membrane assembly, e.g. second surface 10b and/or second surface 12b of FIGS. 1A and 1B, each to a surface of a porous electrode, i.e. surface 40a and/or 42a of FIG. 3. In another method of making membrane-electrode assembly, the exposed surface of a transport protection layer of an electrode assembly, e.g. second surface 10a of FIG. 2, is laminated to a surface of an ion permeable membrane, i.e. surface 20a and/or 20b of FIGS. 1A and 1B. This may be conducted by hand or under heat and/or pressure using conventional lamination equipment. The method of making a membrane-electrode assembly may include direct bonding, e.g. melt bonding of the transport protection layer and the porous electrode and/or the transport protection layer and the ion permeable membrane. If melt bonding is used, the melt bonding techniques previously described to make membrane assemblies and electrode assemblies may be employed to bond the various components of the membrane-electrode assembly.

Any one of the membrane assemblies, electrode assemblies and membrane-electrode assemblies of the present disclosure may be formed during the fabrication of an electrochemical cell or battery. The components of an assembly may be layered on top of one another in the desired order, in a cell or battery, the mechanical aspects of the cell itself may then hold the assembly together. For example, the components of a membrane-electrode assembly; a first porous electrode, a first transport protection layer, an ion permeable membrane, a second transport protection layer and a second porous electrode; may be stacked in this order. The stacked components are then assembled between, for example, the end plates of a single cell or bipolar plates and end plates of a stack having multiple cells, along with any other required gasket/sealing material. The plates, with membrane-electrode assembly there between, are then coupled together, usually by a mechanical means, e.g. bolts, clamps or the like, the plates providing a means for holding the membrane-electrode assembly together and in position within the cell. A membrane-electrode assembly held together in this fashion inherently includes a membrane assembly (ion permeable membrane and transport protection layer) and an electrode assembly (porous electrode and transport protection layer).

Select embodiments of the present disclosure include, but are not limited to, the following:

In a first embodiment, the present disclosure provides a membrane assembly for a liquid flow battery comprising:
an ion permeable membrane having a first surface and an opposed second surface; and
a first transport protection layer having a first surface, an opposed second surface, fluid communication between the first surface and second surface and at least one of a volume porosity and an open area porosity is between about 0.80 and about 0.98, wherein the first surface of the ion permeable membrane is in contact with the first surface of the first transport protection layer and the first transport protection layer comprises at least one of a woven and nonwoven non-conductive substrate comprising fiber; and the water permeability @ 5 kPa of the first transport protection layer is greater than or equal to about 100 ml/(cm2 min).

In a second embodiment, the present disclosure provides a membrane assembly according to the first embodiment further comprising: a second transport protection layer have a first surface, an opposed second surface, fluid communication between the first surface and second surface and at least one of a volume porosity and an open area porosity is between about 0.80 and about 0.98, wherein the second surface of the ion permeable membrane is in contact with the first surface of the second transport protection layer; and the second transport protection layer comprises at least one of a woven and nonwoven non-conductive substrate comprising fiber; and the water permeability @ 5 kPa of the second transport protection layer is greater than or equal to about 100 ml/(cm² min).

In a third embodiment, the present disclosure provides a membrane assembly according to the first or second embodiments, wherein the water permeability @ 5 kPa of the first and the second transport protection layers is greater than or equal to about 200 ml/(cm² min).

In a fourth embodiment, the present disclosure provides a membrane assembly according to the first or second embodiments, wherein the water permeability @ 5 kPa of the first and the second transport protection layers is between about 100 ml/(cm² min) and 1000 ml/(cm² min).

In a fifth embodiment, the present disclosure provides a membrane assembly according to the first or second embodiments, wherein the water permeability @ 5 kPa of the first and second transport protection layers is between about 200 ml/(cm² min) and 1000 ml/(cm² min).

In a sixth embodiment, the present disclosure provides a membrane assembly according to any one of the first through fifth embodiments, wherein the at least one of a woven and nonwoven non-conductive substrate comprises non-conductive polymeric fiber.

In a seventh embodiment, the present disclosure provides a membrane assembly according to the sixth embodiment, wherein the non-conductive polymeric fiber comprises at least one of polyurethanes, polyesters, polyamides, polyethers, polycarbonates, polyimides, polysulphones, polyphenylene oxides, polyacrylates, polymethacylates, polyolefin, styrene and styrene based random and block copolymers, polyvinyl chloride, and fluorinated polymers.

In an eighth embodiment, the present disclosure provides a membrane assembly according to any one of the first through fifth embodiments, wherein the at least one of a woven and nonwoven non-conductive substrate comprises non-conductive inorganic fiber.

In a ninth embodiment, the present disclosure provides a membrane assembly according to the eighth embodiment, wherein the non-conductive inorganic fiber comprises at least one of a ceramic, boron, silicon, magnesium silicate, calcium silicate and rock wool.

In a tenth embodiment, the present disclosure provides a membrane assembly according to any one of the first through ninth embodiments, wherein the thickness of at least one of the first and second transport protection layers is between about 55 microns and 100 microns.

In an eleventh embodiment, the present disclosure provides an electrode assembly for a liquid flow battery comprising:
a porous electrode having a first surface and an opposed second surface comprising carbon fiber;
a first transport protection layer having a first surface, an opposed second surface, fluid communication between the first surface and second surface and at least one of a volume porosity and an open area porosity is between about 0.80 and about 0.98, wherein the first surface of the porous electrode is proximate the second surface of the first transport protection layer and the first transport protection layer comprises at least one of a woven and nonwoven non-conductive substrate comprising fiber; and the water permeability @ 5 kPa of the first transport protection layer is greater than or equal to about 100 ml/(cm2 min).

In a twelfth embodiment, the present disclosure provides a membrane assembly according to the eleventh embodiment, wherein the water permeability @ 5 kPa of the first transport protection layer is greater than or equal to about 200 ml/(cm² min).

In a thirteenth embodiment, the present disclosure provides a membrane assembly according to the eleventh embodiment, wherein the water permeability @ 5 kPa of the first transport protection layer is between about 100 ml/(cm² min) and 1000 ml/(cm² min).

In a fourteenth embodiment, the present disclosure provides a membrane assembly according to the eleventh embodiment, wherein the water permeability @ 5 kPa of the first transport protection layer is between about 200 ml/(cm² min) and 1000 ml/(cm² min).

In a fifteenth embodiment, the present disclosure provides a membrane assembly according to any one of the eleventh through fourteenth embodiments, wherein the porous electrode comprises at least one of carbon paper, carbon felt and carbon cloth.

In a sixteenth embodiment, the present disclosure provides a membrane assembly according to any one of the eleventh through fifteenth embodiments, wherein the porous electrode is hydrophilic.

In a seventeenth embodiment, the present disclosure provides a membrane assembly according to any one of the eleventh through sixteenth embodiments, wherein the at least one of a woven and nonwoven non-conductive substrate comprises non-conductive polymeric fiber.

In an eighteenth embodiment, the present disclosure provides a membrane assembly according to the seventeenth embodiment, wherein the non-conductive polymeric fiber comprises at least one of polyurethanes, polyesters, polyamides, polyethers, polycarbonates, polyimides, polysulphones, polyphenylene oxides, polyacrylates, polymethacylates, polyolefin, styrene and styrene based random and block copolymers, polyvinyl chloride, and fluorinated polymers.

In a nineteenth embodiment, the present disclosure provides a membrane assembly according to any one of the eleventh through eighteenth embodiments, wherein the at least one of a woven and nonwoven non-conductive substrate comprises non-conductive inorganic fiber.

In a twentieth embodiment, the present disclosure provides a membrane assembly according to the nineteenth embodiment, wherein the non-conductive inorganic fiber comprises at least one of a ceramic, boron, silicon, magnesium silicate, calcium silicate and rock wool.

In a twenty-first embodiment, the present disclosure provides a membrane assembly according to any one of the eleventh through twentieth embodiments, wherein the thickness of the first transport protection layer is between about 55 microns and 100 microns.

In a twenty-second embodiment, the present disclosure provides a membrane-electrode assembly for a liquid flow battery comprising:
an ion permeable membrane having a first surface and an opposed second surface;
a first and a second transport protection layer each having a first surface, an opposed second surface, fluid communication between the first surface and second surface and at least one of a volume porosity and an open area porosity is between about 0.80 and about 0.98, wherein the first surface of the ion permeable membrane is in contact with the first surface of the first transport protection layer and the second surface of the ion permeable membrane is in contact with the first surface of the second transport protection layer, and the first and second transport protection layers comprise at least one of a woven and nonwoven non-conductive substrate comprising fiber; and the water permeability @ 5 kPa of at least one of the first and second transport protection layers is greater than or equal to about 100 ml/(cm² min); and
a first and second porous electrode each comprising carbon fiber and each having a first surface and an opposed second surface; wherein the first surface of the first porous electrode is proximate to the second surface of the first transport protection layer and the first surface of the second porous electrode is proximate to the second surface of the second transport protection layer.

In a twenty-third embodiment, the present disclosure provides a membrane-electrode assembly for a liquid flow battery according to the twenty-second embodiment, wherein the water permeability @ 5 kPa of at least one of the first and second transport protection layers is greater than or equal to about 200 ml/(cm² min).

In a twenty-fourth embodiment, the present disclosure provides a membrane-electrode assembly for a liquid flow battery according to the twenty-second embodiment, wherein the water permeability @ 5 kPa of at least one of the first and the second transport protection layers is between about 100 ml/(cm² min) and 1000 ml/(cm² min).

In a twenty-fifth embodiment, the present disclosure provides a membrane-electrode assembly for a liquid flow battery according to the twenty-second embodiment, wherein the water permeability @ 5 kPa of at least one of the first and the second transport protection layers is between about 200 ml/(cm² min) and 1000 ml/(cm² min).

In a twenty-sixth embodiment, the present disclosure provides a membrane-electrode assembly for a liquid flow battery according to any one of the twenty-second through twenty-fifth embodiments, wherein the porous electrode comprises at least one of carbon paper, carbon felt and carbon cloth.

In a twenty-seventh embodiment, the present disclosure provides a membrane-electrode assembly for a liquid flow battery according to any one of the twenty-second through twenty-sixth embodiments, wherein the porous electrode is hydrophilic.

In a twenty-eighth embodiment, the present disclosure provides a membrane-electrode assembly for a liquid flow battery according to any one of the twenty-second through twenty-seventh embodiments, wherein the at least one of a woven and nonwoven non-conductive substrate comprises non-conductive polymeric fiber.

In a twenty-ninth embodiment, the present disclosure provides a membrane-electrode assembly for a liquid flow battery according to the twenty-eighth embodiment, wherein the non-conductive polymeric fiber comprises at least one of wherein the non-conductive polymeric fiber comprises at least one of polyurethanes, polyesters, polyamides, polyethers, polycarbonates, polyimides, polysulphones, polyphenylene oxides, polyacrylates, polymethacylates, polyolefin, styrene and styrene based random and block copolymers, polyvinyl chloride, and fluorinated polymers.

In a thirtieth embodiment, the present disclosure provides a membrane-electrode assembly for a liquid flow battery according to any one of the twenty-second through twenty-ninth embodiments, wherein the at least one of a woven and nonwoven non-conductive substrate comprises non-conductive inorganic fiber.

In a thirty-first embodiment, the present disclosure provides a membrane-electrode assembly for a liquid flow battery according to the thirtieth embodiment, wherein the non-conductive inorganic fiber comprises at least one of at least one of a ceramic, boron, silicon, magnesium silicate, calcium silicate and rock wool.

In a thirty-second embodiment, the present disclosure provides a membrane-electrode assembly for a liquid flow battery according to any one of the twenty-second through thirty-first embodiments, wherein the thickness of at least one of the first and second transport protection layers is between about 55 microns and 100 microns.

In a thirty-third embodiment, the present disclosure provides an electrochemical cell for a liquid flow battery comprising: a membrane assembly according to any one of the first through tenth embodiments.

In a thirty-fourth embodiment, the present disclosure provides an electrochemical cell for a liquid flow battery comprising: an electrode assembly according to any one of the eleventh through twenty-first embodiments.

In a thirty-fifth embodiment, the present disclosure provides an electrochemical cell for a liquid flow battery comprising: a membrane-electrode assembly according to any one of the twenty-second through thirty-second embodiments.

In a thirty-sixth embodiment, the present disclosure provides a liquid flow battery comprising: a membrane assembly according to any one of the first through tenth embodiments.

In a thirty-seventh embodiment, the present disclosure a liquid flow battery comprising: an electrode assembly according to any one of the eleventh through twenty-first embodiments.

In a thirty-eighth embodiment, the present disclosure provides a liquid flow battery comprising: a membrane-electrode assembly according to any one of the twenty-second through thirty-second embodiments.

### EXAMPLES

These examples are merely for illustrative purposes only and are not meant to be limiting on the scope of the appended claims. All parts, percentages, ratios, etc. in the examples and the rest of the specification are by weight, unless noted otherwise. Solvents and other reagents used were obtained from Sigma-Aldrich Chemical Company, St. Louis, Mo. unless otherwise noted.

| Materials | |
|---|---|
| Abbreviation or Trade Name | Description |
| 3M PFSA PEM | 20 micron thick membrane prepared from |
| | 3M825EW following the Membrane |
| | preparation procedure described in the |
| | EXAMPLE section of U.S. Pat. No. |
| | 7,348,088. |
| GDL H2315 | Carbon paper (gas diffusion layer), having a |
| | thickness of 210 microns at 0.025 MPa, an |
| | area weight of 95 g/m², an air permeability of |
| | 400 l/m³ s and a through plane electrical |
| | resistance of 4.5 mOhm/cm² at 1 MPa, |
| | available under the trade designation |
| | “Freudenberg GDL H2315” from Freudenberg |
| | Fuel Cell Component Technologies |
| | SE&CO.KG, Weinheim, Germany. |
| GDL 39AA | Carbon paper, having a thickness of 280 |
| | microns, a basis weight of 50 g/m² and an |
| | electrical resistivity of 5 mOhm/cm², available |
| | under the trade designation “SIGRACET GDL |
| | 39AA” from SGL Group, Wiesbadan, |
| | Germany. |
| 3M825EW | An aqueous solution of a perfluorosulfonic |
| | acid ionomer having an 825 equivalent weight, |
| | available under the trade designation |
| | “3M825EW”, from the 3M Company, St. Paul, |
| | Minnesota. |
| 3M725EW | An aqueous solution of a perfluorosulfonic |
| | acid ionomer having a 725 equivalent weight, |
| | available under the trade designation |
| | “3M725EW”, from the 3M Company. |
| 825EW 3M Ionomer Powder | A spray dried powder of 3M825EW |
| 725EW 3M Ionomer Powder | A spray dried powder of 3M725EW |
| 825EW 3M Ionomer Dispersion | A 20 percent solids dispersion of 825EW 3M |
| | Ionomer Powder in a 70/30 wt./wt. mixture of |
| | ethanol and deionized water. |
| 725EW 3M Ionomer Dispersion | A 3 percent solids dispersion of 725EW 3M |
| | Ionomer Powder in a 70/30 wt./wt. mixture of |
| | ethanol and deionized water. |
| Vanadium (IV) Oxide Sulfate n- | Vanadium (IV) Oxide Sulfate n-Hydrate, 99.9% |
| Hydrate, 99.9% | from Wako Pure Chemical Industries, Ltd., |
| | Osaka, Japan. |
| COLCOAT PX | A condensate of ethyl-silicate, available under |
| | the trade designation COLCOATPX from |
| | COLCOAT CO., LTD. Tokyo, Japan |
| 200Moku | Polypropylene mesh cloth, available under the |
| | trade designation 200Moku, from NBC |
| | Meshtec Inc., Hino, Tokyo, Japan |
| 75(65)-49PTNW | Polyethylene terephthalate mesh cloth, |
| | available under the trade designation “75(65)- |
| | 49PTNW”, from DIO CHEMICALS, LTD., |
| | Chuo-ku, Tokyo, Japan |
| T-NO.90T | Polyethylene terephthalate mesh cloth, |
| | available under the trade designation “75(65)- |
| | 49PTNW”, from “T-NO.90T”, from NBC |
| | Meshtec Inc., Hino, Tokyo, Japan |
| SEFAR PET 07-64/45 | Polyethylene terephthalate mesh cloth, |
| | available under the trade designation “SEFAR |
| | PET 07-64/45”, from Sefar AG, Heiden, |
| | Switzerland, via distributor Semitec Co., Ltd., |
| | Osaka, Japan |
| SEFAR PET 07-30/21 | Polyethylene terephthalate mesh cloth, |
| | available under the trade designation “SEFAR |
| | PET 07-30/21”, from Sefar AG, Heiden, |
| | Switzerland, via distributor Semitec Co., Ltd., |
| | Osaka, Japan |
| ELTAS Polypropylene PO3015 | Polypropylene nonwoven, available under the |
| | trade designation “ELTAS Polypropylene |
| | PO3015”, from Asahi Kasei Co., Ltd., |
| | Chiyoda-ku, Tokyo, Japan |
| Grade 8000111 Glass | Micro glass fiber nonwoven, available under |
| | the trade designation “Grade 8000111 Glass”, |
| | from Hollingsworth & Vose, MA, USA |
| POREFLON membrane HPW-045-30 | PTFE nonwoven, available under the trade |
| | designation “POREFLON membrane HPW- |
| | 045-30”, from Sumitomo Electric Industries, |
| | Ltd., Osaka, Japan |

### Test Methods and Procedures

### Cell Short Resistance Test Method

Electronic short measurements were carried out using a digital multimeter MAS-344, available from Precision Mastech Enterprise Co., Ltd, Hong Kong. The short resistance measurement was conducted by connecting terminals of the tester to current collector plates of the cell assembly with cables (See “Electrochemical Cell Preparation Procedure (generic)” below for description of cell assembly). All measurements were done in ambient condition without any gas or liquid stream into the cell assembly. Results are recorded in ohms-cm².

### Cell Resistance Test Method

Two plastic bottles (100 ml volume) were prepared as the positive and negative storage electrolyte containers. 30 ml of V4 solution (prepared as described in the Example Preparation Procedure) was added into the positive electrolyte storage container and 30 ml of V3 solution (prepared as described in the Example Preparation Procedure) was added into the negative electrolyte storage container. The tubing connections from bottles to the pump and the cell were attached. (See Electrochemical Cell Preparation Procedure (generic) below for description of cell assembly). The electrolytes were pumped from the electrolyte storage containers at 12 ml/min by using a peristaltic pump, available under the trade designation “Master Flex”, Cole-Parmer Instrument Company, Vernon Hills, Ill., USA. The electrical cable connections were attached.

The cell resistance was given trough electrochemical measurement by using a potentiostat available as Iviumstat from Ivium Technologies, Eindhoven, Netherlands. The cell resistance was defined as a total resistance given by Ohm's law with cell voltage and applied current density in discharging of the Redox Flow Battery, and it comprised of ohmic resistance and charge mass transport resistance. The ohmic resistance at 1 kHz was directly measured by using impedance meter available as model 3569, available from TSURUGA ELECTRIC CORPORATION, 1-3-23, Minamisumiyoshi Sumiyoshi-ku, Osaka-shi, Osaka-fu, Japan. Thereby the charge mass transport resistance was given by subtracting the measured ohmic resistance from the calculated cell resistance. Results are recorded in ohms-cm².

Protocol for Cell resistance measurement trough discharging was illustrated below.

### Step 1: Initial Charge

1-1) Charge cell at 80 mA/cm2 to a voltage of 1.8V
1-2) Hold at 1.6V until the current has dropped below 5 mA/cm²
1-3) Hold at open circuit voltage (OCV) for 30 minutes

### Step 2: Cell Polarization in Discharging

2-1) Discharge cell at 160 mA/cm² for 45 seconds
2-2) Rest for 180 seconds at OCV
Repeat 2-1 and 2-2 17 times
2-3) Discharge cell at 140 mA/cm² for 45 seconds
2-4) Rest for 180 seconds
2-5) Discharge cell at 120 mA/cm² for 45 seconds
2-6) Rest for 180 seconds
2-7) Discharge cell at 100 mA/cm2 for 45 seconds
2-8) Rest for 180 seconds
2-9) Discharge cell at 80 mA/cm2 for 45 seconds
2-10) Rest for 180 seconds
2-11) Discharge cell at 60 mA/cm² for 45 seconds
2-12) Rest for 180 seconds

Between each discharge a 180 seconds rest period was utilized to allow the cell to return to steady state before the next pulse. Voltage and current values were recorded as a function of time. The cell resistance values were calculated by taking the difference between the rest voltage and the minimum voltage during discharge and dividing it by the applied current.

### Thickness Test Method

All thickness values less than 1 mm were measured with ID-S112 Digimatic Indicator, available from Mitsutoyo Corporation, Kanagawa, Japan. The applied pressure to the sample in vertical direction through a tip (17 mm²) was 200 kPa. Results are recorded in microns.

Woven Mat Opening (x/y) Test Method

The dimensions of the opening of a woven mat were measured with a conventional microscope, available under the trade designation “BX51”, OLYMPUS CORPORATION, Tokyo, Japan. The microscope equips a CCD camera and the obtained image was analyzed by using a specific software, available under the trade designation “FLOVAL Filing System”, from FLOVEL CO., LTD., Tokyo, Japan. When the opening window appeared as a rectangle shape, shorter side was shown as x-axis and longer side was shown as y-axis. Results are recorded as an average of 5 measurements in microns.

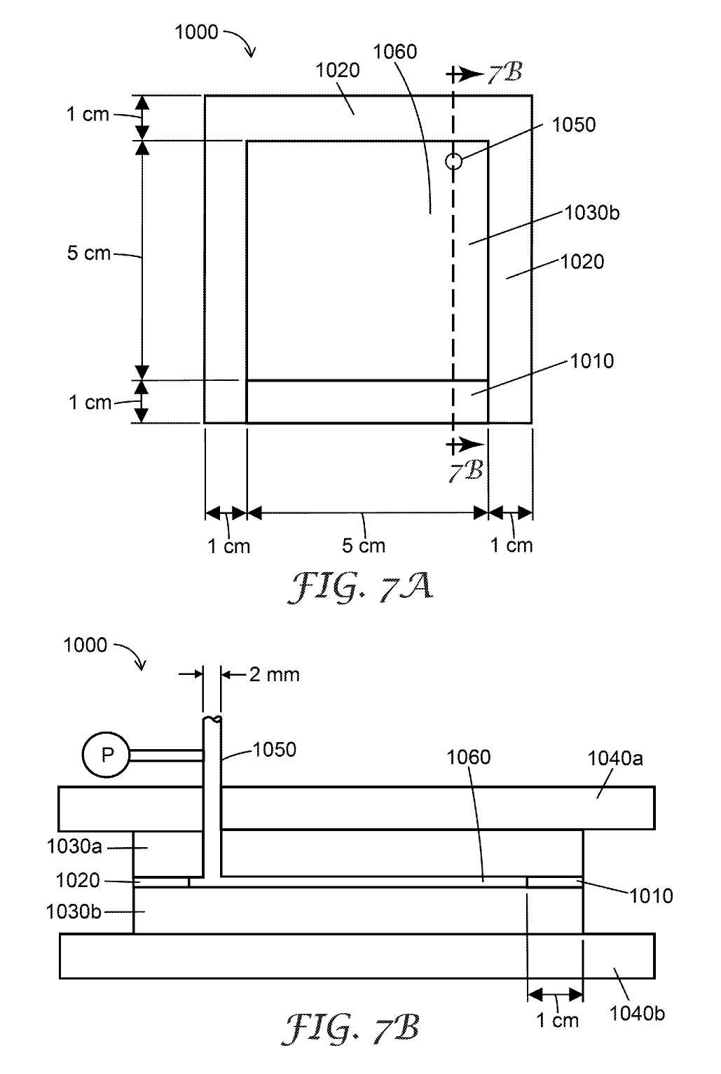

### In-Plane Water Permeability Test Method (See FIGS. 7A and 7B)

The transportation protection layer (TPL) was die cut by hand into 5 cm×1 cm pieces, using a conventional die, for in-plane water permeability testing. The water permeability test apparatus 1000 is shown in FIGS. 7A and 7B. FIG. 7A shows a schematic cross-sectional top view (through the plane of U-shaped gasket 1020 and transportation protection layer 1010) and FIG. 7B shows a schematic cross-sectional side view (through the line indicated in FIG. 7A) of the water permeability test apparatus 1000. Water permeability test apparatus 1000 includes a transportation protection layer 1010 cut in the form of a sheet of the size indicated above, a U-shaped gasket 1020, an upper graphite block 1030a and a lower graphite block 1030b, an upper stainless steel plate 1040a and a lower stainless steel plate 1040b, a fluid inlet tube 1050, to supply water to the apparatus via a peristaltic pump (not shown) and a channel 1060, formed between the carbon plates, via U-shaped gasket 1020. Channel 1060 allows fluid flow, e.g. water flow, to the transportation protection layer 1010. U-shaped gasket 1020 is placed along the perimeter on the upper major surface of lower graphite block 1030b. Transport protection layer 1010 is also placed on the upper, major surface of lower graphite block 1030b and positioned as shown in FIG. 7A. Upper graphite block 1030a was then placed on top of U-shaped gasket 1020 and transportation protection layer 1010, as shown in FIG. 7B. U-shaped gasket 1020, was selected to be several microns thinner than the thickness of transport protection layer 1010. U-shaped gasket 1020 was either a silicone reinforced glass fiber mesh and/or a polyimide optical grade film, which may be combined to hit the target thickness relative to the TPL thickness. The stack, which included upper graphite block 1030a, lower graphite block 1030b, U-shaped gasket 1020 and transport protection layer 1010 was sandwiched between upper stainless steel plate 1040a and lower stainless steel plate 1040b and was fixed in position by bolts and nuts (not shown). During tightening of the bolts, U-shaped gasket 1020 received sufficient pressure to prevent water from leaking outside of water permeability test apparatus 1000, but U-shaped gasket 1020 was not compressed by more than 2%. Upper stainless steel plate 1040a and upper graphite block 1030a both included a hole cut through their thicknesses and aligned with one another to allow fluid inlet tube 1050, which had a 2 mm internal diameter, to be mounted therein. Fluid inlet tube 1050 includes pressure transducer, P.

DI water was injected into water permeability test apparatus 1000 through fluid inlet tube 1050 via a peristaltic pump, available under the trade designation “Master Flex”, from Cole-Parmer Instrument Company, Vernon Hills, Ill., USA. Water flowed into channel 1060 and flows out of the apparatus through transportation protection layer 1010. Inlet pressure was measured by pressure transducer P, available under the trade designation “KL60-173”, from Nagano Keiki Co., Ltd., Tokyo, Japan, at three different flow rates of water (34.3, 68.3 and 103.4 ml/min) and then a linear regression expression between the inlet pressure and the flow rate was calculated using least squares approach. Based on this equation (flow rate vs pressure), the flow rate of DI water at a constant pressure, 5 kPa was determined. This value was then divided by the area available for water to flow out of the apparatus (the thickness of the transport protection layer 1010×the length of the transport protection layer, 5 cm) and was then used as the metric to show the in-plane water permeability. The units of this parameter, called Water Permeability @5 kPa, were ml/(cm² min).

### Volume Porosity Calculation

The Volume Porosity of a given transport protection layer was calculated from the previously discussed equation, Volume Porosity=1−(Ds/Dm).

### Example Preparation Procedure

### Making Method of 20% Solid 825EW Ionomer Solution

336 g of ethanol and 144 g of DI water were added to a 1 L glass bottle with a stir bar. 120 g of powdered 825EW ion-conductive polymer (3M 825EW ionomer) was added and stirred for a couple hours until uniformly dispersed.

### Making Method of 3% Solid 725EW Ionomer Solution

135.8 g of ethanol and 58.2 g of DI water were added to a 500 mL glass bottle with a stir bar. 6 g of powdered 725EW ion-conductive polymer (3M 725EW ionomer) was added and stirred for a couple hours until uniformly dispersed.

### Making Method of Ion Exchange Membrane

The 40% solid dispersion of 825EW ion-conductive polymer (3M 825EW ionomer) (Sulfonic acid group equivalent weight: 825) which is available from Dyneon Co. was coated on polyimide substrate (50 microns thick) by using a die coater and then annealed at 200 degree C. for 3 minutes. The thickness of PEM was adjusted to 20 μm.

### Making Method of Electrode

Carbon paper, 39AA (available from SGL Carbon Co., LTD.) was thermally treated at 400 degree C. for 24 hours under ambient condition to produce hydrophilic surface. In this manner, the electrode was prepared.

### Making Method of Expanded Polypropylene Mesh Component

Commercially available polypropylene meshes are typically thicker than 150 microns, so thinner polypropylene mesh cloths were produced by biaxially-stretching of commercially available mesh cloths. The original fabric (mesh) was set on biaxial-stretcher located in heat chamber, available from IMOTO MACHINERY CO., LTD., Kyoto, Japan, by chucking and was expanded at 140 degree C. at 10 mm/min for a specified period of time according to a target structure. The expanded polypropylene meshes were thinner and had larger openings than the original.

Making Method of the Transportation Protection Layer (TPL) Covered with Ionomer Coating

The mesh cloth or non-woven component was dipped into 3% solid ionomer (725EW) dispersion in ethanol/water (=70%/30%) and pulled out. Then excess dispersion was brown off with air jet flow and the transportation protection component was dried at 120 degree C. for 5 minutes. In this manner, the transportation protection layer covered with ionomer coating was prepared.

Making Method of the Transportation Protection Layer (TPL) Covered with Condensate of Ethyl-Silicate Coating

The transportation protection layer (TPL) covered with condensate of ethyl-silicate coating was prepared similarly to the TPL covered with ionomer coating, except the 3% solid ionomer (725EW) dispersion was replaced by the 2% condensate of ethyl-silicate dispersion.

### Making Method of VO2-V4 Solution (Electrolyte for Positive Electrode)

704.3 grams of DI water was measured and added to a plastic bottle. In the hood, 528.5 grams of 9S-98% (96.5% av.) sulfuric acid was slowly poured into the said plastic bottle, monitoring the heat of any reaction. In this manner, 1 liter of 5.2M sulfuric acid solution was prepared. The mass of 1 L volumetric glass flask was zeroed on scale and then 673.2 g of Vandyl (IV) sulfuric 3.4 hydrate (VOSO4 3.4H2O, 3 mol, 50.94 g/mol @ 3 moles) DI water was slowly added, while mixing, to reach the 1 liter mark on the volumetric flask. Content of volumetric flask was poured into a 2 liter plastic bottle. The flask was filled with 5.2 sulfuric acid solution and then it was added into the plastic bottle. In this manner, 2 liters of 1.5M VOSO, 2.6M H2SO4-V4 solution for positive electrolyte was prepared.

### Making Method of VO2-V3 Solution (Electrolyte for Negative Electrode)

Two plastic bottles (100 ml volume) were prepared for positive and negative electrolyte. 30 ml of V4 solution was added into each plastic bottle. The tubing connections from bottle to the pump and the cell were attached. The fluid pumping through the pump was started and the electrical cable connections were attached. Flow rate of solution was set at 12 ml/min.

OCV was checked to insure that connections have been made and solution is pumping. Then a charging current of 80 mA/cm2 was applied until the cell voltage reaches 1.8V. The cell voltage was kept at 1.8V until the current has decayed to below 2 mA/cm2. At this point, two solutions of different states were in two plastic bottles. There is a V5 solution (with yellowish color) in the bottle for positive electrolyte and a V3 solution (with greenish color) in the other bottle for negative electrolyte. In this manner, the V3 solution for negative electrolyte was prepared.

### Electrochemical Cell Preparation Procedure (Generic)

Electrode material and the transportation protection layer (TPL) was die cut by hand into 5 cm² pieces, using a conventional die. A piece of 5 cm² die-cut TPL were placed each side of 20 um 3M 825EW membrane. Two pieces of 5 cm² die-cut electrode material were placed adjacent to the TPL. The flow plates of the test cell were commercially available single serpentine flow channel with 5 cm² active area, available from Fuel Cell Technologies, Albuquerque, N. Mex. Examples being tested were assembled in the cell with a general configuration as that shown in FIG. 4, with the 5 cm² area of the Example aligning with the 5 cm² area of the flow plates. The cell assembly further included two picture frame gaskets, each adjacent to one of the plates. The size of the gasket opening was configure to allow the carbon paper (electrode) and the TPL to align with the gasket frame, allowing the gasket to seal on the ion exchange membrane. After assembling in the cell, the bolts of the cell were tightened in a star shaped pattern to a 110 in lbf torque. The picture frame gaskets were used as spacers, too. The picture frame gaskets were used to set a hard stop for the compression of each carbon paper (electrode). The picture frame gaskets were either a silicone reinforced glass fiber mesh and/or a polyimide optical grade film and were combined to hit the target thickness corresponding to the hard stop for 50% compression. The compression was defined as the following equation:

Compression (%)=[(Tp+Te−Tg)/Te]×100

where,
Tp was the thickness of the transport protection layer.
Te was the thickness of the electrode.
Tg was the thickness of the gasket.

### Preparation Procedure of Example 1: (Membrane-Electrode Assembly)

Polypropylene mesh cloth, 200Moku was die cut to a 9 cm×9 cm piece and set on biaxial-stretcher located in heat chamber by chucking. Then it was expanded at 140 degree C. at 10 mm/min for 11 minutes 30 seconds. The expanded mesh cloth, the TPL of Example 1 (Ex. 1) was die cut by hand into 5 cm² pieces and then assembled with the electrodes and the membrane in the described method in “Electrochemical Cell Preparation Procedure (generic)”. In forming the membrane-electrode assembly, as described, a membrane assembly and an electrode assembly was inherently formed as well.

### Preparation Procedure of Example 2: (Membrane-Electrode Assembly)

Polypropylene mesh cloth, 200Moku was die cut to a 9 cm×9 cm piece and set on biaxial-stretcher located in heat chamber by chucking. Then it was expanded at 140 degree C. at 10 mm/min for 11 minutes 30 seconds. The expanded mesh cloth was dipped into 3% solid ionomer (725EW) dispersion in ethanol/water (=70%/30%) and pulled out. The excess dispersion was brown off with air jet flow and then the mesh cloth was dried at 120 degree C. for 5 minutes. The obtained mesh cloth, the TPL of Example 2 (Ex. 2) was die cut by hand into 5 cm² pieces and then assembled with the electrodes and the membrane in the above described method in “Electrochemical Cell Preparation Procedure (generic)”.

### Preparation Procedure of Example 3: (Membrane-Electrode Assembly)

Example 3 (Ex. 3) was prepared similarly to Example 2, except 11 minutes 30 seconds was replaced by 14 minutes in stretching process.

### Preparation Procedure of Comparative Example 4: (Membrane Electrode Assembly)

Comparative Example 4 (CE-4) was prepared similarly to Example 2, except the expanded polypropylene mesh cloth was replaced by polyethylene terephthalate mesh cloth, 75(65)-49PTNW as received.

### Preparation Procedure of Comparative Example 5: (Membrane-Electrode Assembly)

Comparative Example 5 (CE-5) was prepared similarly to Example 1, except the expanded polypropylene mesh cloth was replaced by polyethylene terephthalate mesh cloth, 75(65)-49PTNW as received.

### Preparation Procedure of Comparative Example 6: (Membrane-Electrode Assembly)

Comparative Example 6 (CE-6) was prepared similarly to Example 2, except the expanded polypropylene mesh cloth was replaced by polyethylene terephthalate mesh cloth, T-NO. 90T as received.

### Preparation Procedure of Comparative Example 7: (Membrane-Electrode Assembly)

Comparative Example 7 (CE-7) was prepared similarly to Example 2, except the expanded polypropylene mesh cloth was replaced by polyethylene terephthalate mesh cloth, SEFAR PET 07-64/45 as received.

### Preparation Procedure of Comparative Example 8: (Membrane-Electrode Assembly)

Comparative Example 8 (CE-8) was prepared similarly to Example 2, except the expanded polypropylene mesh cloth was replaced by polyethylene terephthalate mesh cloth, SEFAR PET 07-30/21 as received.

### Preparation Procedure of Comparative Example 9: (Membrane-Electrode Assembly)

Comparative Example 9 (CE-9) was prepared similarly to Example 1, except the expanded polypropylene mesh cloth was replaced by Polypropylene nonwoven, ELTAS Polypropylene PO3015 as received.

### Preparation Procedure of Comparative Example 10: (Membrane-Electrode Assembly)

Comparative Example 10 (CE-10) was prepared similarly to Example 2, except the expanded polypropylene mesh cloth was replaced by Polypropylene nonwoven, ELTAS Polypropylene PO3015 as received and the 725EW ionomer dispersion was replaced by COLCOAT PX as received.

### Preparation Procedure of Comparative Example 11: (Membrane-Electrode Assembly)

Micro glass fiber nonwoven, Grade 8000111 Glass was cut to a 10 cm×15 cm piece and placed in Muffle Furnace FC310, available from Yamato Scientific Co., Ltd., Tokyo, Japan. Then the temperature was raised to 350 degree C. and kept for 10 minutes. The treated nonwoven was dipped into 3% solid ionomer (725EW) dispersion in ethanol/water (=70%/30%) and pulled out to flat PTFE sheet. Then it dried for 10 minutes at room temperature and for 5 minutes at 120 degree C.

Comparative Example 11 (CE-11) was prepared similarly to Example 1, except the expanded polypropylene mesh cloth was replaced by the micro glass fiber nonwoven treated in the above-method.

### Preparation Procedure of Comparative Example 12: (Membrane-Electrode Assembly)

Comparative Example 12 (CE-12) was prepared similarly to Example 1, except the expanded polypropylene mesh cloth was replaced by PTFE nonwoven, POREFLON membrane HPW-045-30 as received.

### Preparation Procedure of Comparative Example 13: (Membrane-Electrode Assembly)

Comparative Example 13 (CE-13) was prepared similarly to Comparative Example 12, except double sheets of PTFE nonwoven at each side were applied.

### Preparation Procedure of Comparative Example 14: (Membrane-Electrode Assembly)

Comparative Example 14 (CE-14) was prepared in the manor described above in “Electrochemical Cell Preparation Procedure (generic)” without the TPLs.

### Preparation Procedure of Comparative Example 15: (Membrane-Electrode Assembly)

Comparative Example 15 (CE-15) was prepared in the manor described above in “Electrochemical Cell Preparation Procedure (generic)” with 50 microns thick 3M 825EW membrane without the TPLs.

The Examples and Comparative Examples were tested using the Test Methods described above. Results are show in Table 1 and Table 2 below. Opening dimensions were measured on Examples 1, 2 and 3. Comparative Examples used supplier cited Opening values.

TABLE 1

| | | | | TPL | | | | |
|---|---|---|---|---|---|---|---|---|
| | | | | Opening | | Water | | |
| | | TPL | | Dimensions | TPL | permeability | | Membrane |
| | | Surface | TPL | (x/y) | Thickness | @5 kPa | Volume | Thickness |
| Example | TPL | Modifier | Type | (microns) | (microns) | (ml/[cm² min]) | Porosity | (microns) |
| Ex. 1 | PP | PP | Woven | 350/530 | 75 | 212.8 | 0.842 | 20 |
| | | | Mat | | | | | |
| Ex. 2 | PP | Ionomer | Woven | 350/530 | 75 | 220.0 | 0.838 | 20 |
| | | | Mat | | | | | |
| Ex. 3 | PP | Ionomer | Woven | 445/800 | 60 | 203.9 | 0.857 | 20 |
| | | | Mat | | | | | |
| CE-4 | PET | Ionomer | Woven | 290/340 | 74 | 83.0 | 0.838 | 20 |
| | | | Mat | | | | | |
| CE-5 | PET | PET | Woven | 290/340 | 74 | 92.3 | 0.860 | 20 |
| | | | Mat | | | | | |
| CE-6 | PET | Ionomer | Woven | 202/202 | 130 | 95.5 | 0.700 | 20 |
| | | | Mat | | | | | |
| CE-7 | PET | Ionomer | Woven | 64/64 | 50 | 65.4 | 0.688 | 20 |
| | | | Mat | | | | | |
| CE-8 | PET | ionomer | Woven | 30/30 | 50 | 40.8 | 0.506 | 20 |
| | | | Mat | | | | | |
| CE-9 | pp | PP | Non- | — | 70 | 29.8 | 0.77.9 | 20 |
| | | | woven | | | | | |
| CE-10 | pp | PX | Non- | — | 70 | 26.9 | 0.76.9 | 20 |
| | | | woven | | | | | |
| CE-11 | GF | Ionomer | Non- | — | 120 | 31.4 | 0.828 | 20 |
| | | | woven | | | | | |
| CE-12 | PTFE | PTFE | Non- | — | 25 | 2.9 | 0.787 | 20 |
| | | | woven | | | | | |
| CE-13 | PTFE | PTFE | Non- | — | 50 | 2.9 | 0.787 | 20 |
| | | | woven | | | | | |
| CE-14 | — | — | — | — | — | — | — | 20 |
| CE-15 | — | — | — | — | — | — | — | 50 |

PP: Polypropylene.
PET: Polyethylene terephthalate
PX: COLCOAT PX

TABLE 2

| | Short | Cell resistance in discharge | | |
|---|---|---|---|---|
| | Resistance | Total | Ohmic | Mass transport |
| Example | (ohm-cm²) | (ohm-cm²) | (ohm-cm²) | (ohm-cm²) |
| Ex. 1 | >10k | 0.563 | 0.205 | 0.359 |
| Ex. 2 | >10k | 0.561 | 0.195 | 0.365 |
| Ex. 3 | >10k | 0.542 | 0.173 | 0.370 |
| CE-4 | >10k | 0.611 | 0.259 | 0.352 |
| CE-5 | >10k | 0.657 | 0.301 | 0.356 |
| CE-6 | >10k | 0.676 | 0.300 | 0.376 |
| CE-7 | >10k | 0.666 | 0.306 | 0.360 |
| CE-8 | >10k | 0.686 | 0.238 | 0.448 |
| CE-9 | >10k | 0.765 | 0.298 | 0.467 |
| CE-10 | 7k | 0.759 | 0.274 | 0.485 |
| CE-11 | >10k | 0.674 | 0.285 | 0.390 |
| CE-12 | 500 | 0.687 | 0.295 | 0.392 |
| CE-13 | >10k | 0.683 | 0.277 | 0.406 |
| CE-14 | 40 | N/A | N/A | N/A |
| CE-15 | >10k | 0.863 | 0.312 | 0.550 |

1. A membrane assembly for a liquid flow battery comprising:
an ion permeable membrane having a first surface and an opposed second surface; and
a first transport protection layer having a first surface, an opposed second surface, fluid communication between the first surface and second surface and at least one of a volume porosity and an open area porosity is between about 0.80 and about 0.98, wherein the first surface of the ion permeable membrane is in contact with the first surface of the first transport protection layer and the first transport protection layer comprises at least one of a woven and nonwoven non-conductive substrate comprising fiber; and the water permeability @ 5 kPa of the first transport protection layer is greater than or equal to about 100 ml/(cm² min).

2. The membrane assembly for a liquid flow battery of claim 1, further comprising a second transport protection layer have a first surface, an opposed second surface, fluid communication between the first surface and second surface and at least one of a volume porosity and an open area porosity is between about 0.80 and about 0.98, wherein the second surface of the ion permeable membrane is in contact with the first surface of the second transport protection layer; and the second transport protection layer comprises at least one of a woven and nonwoven non-conductive substrate comprising fiber; and the water permeability @ 5 kPa of the second transport protection layer is greater than or equal to about 100 ml/(cm² min).

3. The membrane assembly for a liquid flow battery of claim 1, wherein the water permeability @ 5 kPa of the first and second transport protection layers is greater than or equal to about 200 ml/(cm² min).

4. The membrane assembly for a liquid flow battery of claim 1, wherein the water permeability @ 5 kPa of the first and the second transport protection layers is between about 100 ml/(cm² min) and 1000 ml/(cm² min).

5. The membrane assembly for a liquid flow battery of claim 1, wherein the water permeability @ 5 kPa of the first and second transport protection layers is between about 200 ml/(cm² min) and 1000 ml/(cm² min).

6. The membrane assembly for a liquid flow battery of claim 1, wherein the at least one of a woven and nonwoven non-conductive substrate comprises non-conductive polymeric fiber.

7. The membrane assembly for a liquid flow battery of claim 6, wherein the non-conductive polymeric fiber comprises at least one of polyurethanes, polyesters, polyamides, polyethers, polycarbonates, polyimides, polysulphones, polyphenylene oxides, polyacrylates, polymethacylates, polyolefin, styrene and styrene based random and block copolymers, polyvinyl chloride, and fluorinated polymers.

8. The membrane assembly for a liquid flow battery of claim 1, wherein the at least one of a woven and nonwoven non-conductive substrate comprises non-conductive inorganic fiber.

9. The membrane assembly for a liquid flow battery of claim 8, wherein the non-conductive inorganic fiber comprises at least one of a ceramic, boron, silicon, magnesium silicate, calcium silicate and rock wool.

10. The membrane assembly for a liquid flow battery of claim 1, wherein the thickness of at least one of the first and second transport protection layers is between about 55 microns and 100 microns.

11. An electrode assembly for a liquid flow battery comprising:
a porous electrode having a first surface and an opposed second surface comprising carbon fiber;
a first transport protection layer having a first surface, an opposed second surface, fluid communication between the first surface and second surface and at least one of a volume porosity and an open area porosity is between about 0.80 and about 0.98, wherein the first surface of the porous electrode is proximate the second surface of the first transport protection layer and the first transport protection layer comprises at least one of a woven and nonwoven non-conductive substrate comprising fiber; and the water permeability @ 5 kPa of the first transport protection layer is greater than or equal to about 100 ml/(cm² min).

12. The electrode assembly for a liquid flow battery of claim 11, wherein the water permeability @ 5 kPa of the first transport protection layer is greater than or equal to about 200 ml/(cm² min).

13. The electrode assembly for a liquid flow battery of claim 11, wherein the water permeability @ 5 kPa of the first transport protection layer is between about 100 ml/(cm² min) and 1000 ml/(cm² min).

14. The electrode assembly for a liquid flow battery of claim 11, wherein the water permeability @ 5 kPa of the first transport protection layer is between about 200 ml/(cm² min) and 1000 ml/(cm² min).

15. The electrode assembly for a liquid flow battery of claim 11, wherein the porous electrode comprises at least one of carbon paper, carbon felt and carbon cloth.

16. The electrode assembly for a liquid flow battery of claim 11, wherein the porous electrode is hydrophilic.

17. The electrode assembly for a liquid flow battery of claim 11, wherein the at least one of a woven and nonwoven non-conductive substrate comprises non-conductive polymeric fiber.

18. The electrode assembly for a liquid flow battery of claim 17, wherein the non-conductive polymeric fiber comprises at least one of polyurethanes, polyesters, polyamides, polyethers, polycarbonates, polyimides, polysulphones, polyphenylene oxides, polyacrylates, polymethacylates, polyolefin, styrene and styrene based random and block copolymers, polyvinyl chloride, and fluorinated polymers.

19. The electrode assembly for a liquid flow battery of claim 11, wherein the at least one of a woven and nonwoven non-conductive substrate comprises non-conductive inorganic fiber.

20. The electrode assembly for a liquid flow battery of claim 19, wherein the non-conductive inorganic fiber comprises at least one of a ceramic, boron, silicon, magnesium silicate, calcium silicate and rock wool.

21-38. (canceled)
